(19) United States
(12) Patent Application Publication
(10) Pub. No.: US 2025/0097752 A1
(43) Pub. Date: Mar. 20, 2025

(54) SENSING TERMINAL SELECTION METHOD AND APPARATUS AND COMMUNICATION DEVICE

(71) Applicant: VIVO MOBILE COMMUNICATION CO., LTD., Dongguan (CN)

(72) Inventors: Yannan YUAN, Dongguan (CN); Dajie JIANG, Dongguan (CN)

(73) Assignee: VIVO MOBILE COMMUNICATION CO., LTD., Dongguan (CN)

(21) Appl. No.: 18/963,475

(22) Filed: Nov. 27, 2024

Related U.S. Application Data
(63) Continuation of application No. PCT/CN2023/096060, filed on May 24, 2023.

(30) Foreign Application Priority Data
May 30, 2022 (CN) 202210602525.7

(51) Int. Cl. H04W 24/10; H04B 17/309; H04B 17/318; H04W 64/00

(52) U.S. Cl. CPC H04W 24/10; H04B 17/328; H04B 17/346; H04W 64/00

(57) ABSTRACT

This application discloses a sensing terminal selection method and apparatus and a communication device. The sensing terminal selection method includes: A first device determines a first condition for selecting a sensing terminal, where the first condition includes a geographical location requirement for the sensing terminal to participate in sensing, or a measurement quantity value requirement corresponding to the geographical location requirement.

### CROSS-REFERENCE TO RELATED APPLICATIONS

This application is a continuation of International Application No. PCT/CN2023/096060, filed May 24, 2023, which claims priority to Chinese Patent Application No. 202210602525.7, filed May 30, 2022. The entire contents of each of the above-referenced applications are expressly incorporated herein by reference.

### TECHNICAL FIELD

This application pertains to the field of wireless communications technologies, and specifically, to a sensing terminal selection method and apparatus and a communication device.

### BACKGROUND

In a 5th generation (5G) mobile communication positioning-related scenario, a clear User Equipment (UE, also referred to as a terminal) Identifier (ID) is present, so that a Location Management Function (LMF) may directly interact with a UE based on the UE ID. However, for a sensing service, there is a problem of which network function selects a UE and which UEs are selected for sensing.

### SUMMARY

Embodiments of this application provide a sensing terminal selection method and apparatus and a communication device.

According to a first aspect, a sensing terminal selection method is provided, including:

A first device determines a first condition for selecting a sensing terminal, where the first condition includes a geographical location requirement for the sensing terminal to participate in sensing, and/or a measurement quantity value requirement corresponding to the geographical location requirement.

According to a second aspect, a sensing terminal selection method is provided, including:

A terminal receives a sensing request, where the sensing request includes a first condition, and the first condition includes a geographical location requirement for a sensing terminal to participate in sensing, and/or a measurement quantity value requirement corresponding to the geographical location requirement.

The terminal determines, according to the first condition, whether the terminal is capable of participating in sensing.

In a case that the terminal is capable of participating in the sensing, the terminal sends a sensing response.

According to a third aspect, a sensing terminal selection method is provided, including:

A base station obtains a first condition, where the first condition includes a geographical location requirement for a sensing terminal to participate in sensing, and/or a measurement quantity value requirement corresponding to the geographical location requirement.

The base station executes at least one of the following:
determining a candidate sensing terminal list according to the first condition, and sending a sensing response, where the sensing response includes the candidate sensing terminal list; or
broadcasting the first condition.

According to a fourth aspect, a sensing terminal selection apparatus is provided, including:
a first determining module, configured to determine a first condition for selecting a sensing terminal, where the first condition includes a geographical location requirement for the sensing terminal to participate in sensing, and/or a measurement quantity value requirement corresponding to the geographical location requirement.

According to a fifth aspect, a sensing terminal selection apparatus is provided, including:
a receiving module, configured to receive a sensing request, where the sensing request includes a first condition, and the first condition includes a geographical location requirement for a sensing terminal to participate in sensing, and/or a measurement quantity value requirement corresponding to the geographical location requirement;
a first determining module, configured to determine, according to the first condition, whether the apparatus is capable of participating in sensing; and
a sending module, configured to: in a case that the apparatus is capable of participating in the sensing, send a sensing response.

According to a sixth aspect, a sensing terminal selection apparatus is provided, including:
a receiving module, configured to obtain a first condition, where the first condition includes a geographical location requirement for a sensing terminal to participate in sensing, and/or a measurement quantity value requirement corresponding to the geographical location requirement; and
a first determining module, configured to perform at least one of the following:
determining a candidate sensing terminal list according to the first condition, or sending a sensing response, where the sensing response includes the candidate sensing terminal list; and
broadcasting the first condition.

According to a seventh aspect, a communication device is provided. The terminal includes a processor and a memory. The memory stores a program or an instruction that is executable on the processor, and the program or the instruction is executed by the processor to implement the steps of the method according to the first aspect, the second aspect, or the third aspect.

According to an eighth aspect, a network side device is provided, including a processor and a communication interface. The processor is configured to determine a first condition for selecting a sensing terminal, where the first condition includes a geographical location requirement for the sensing terminal to participate in sensing, and/or a measurement quantity value requirement corresponding to the geographical location requirement.

According to a ninth aspect, a terminal is provided, including a processor and a communication interface. The communication interface is configured to receive a sensing request, where the sensing request includes a first condition, and the first condition includes a geographical location requirement for a sensing terminal to participate in sensing, and/or a measurement quantity value requirement corresponding to the geographical location requirement. The processor is configured to determine, according to the first condition, whether the terminal is capable of participating in sensing. The communication interface is further configured to: in a case that the terminal is capable of participating in the sensing, send a sensing response.

According to a tenth aspect, a network side device is provided, including a processor and a communication interface. The processor is configured to obtain a first condition, where the first condition includes a geographical location requirement for a sensing terminal to participate in sensing, and/or a measurement quantity value requirement corresponding to the geographical location requirement; and determine a candidate sensing terminal list according to the first condition. The communication interface is further configured to send a sensing response, where the sensing response includes the candidate sensing terminal list.

According to an eleventh aspect, a communication system is provided, including a sensing function node and a terminal. The sensing function node may be configured to perform the steps of the method according to the first aspect, and the terminal may be configured to perform the steps of the method according to the second aspect.

According to a twelfth aspect, a communication system is provided, including a sensing function node and a base station. The sensing function node may be configured to perform the steps of the method according to the first aspect, and the base station may be configured to perform the steps of the method according to the third aspect.

According to a thirteenth aspect, a communication system is provided, including a base station and a terminal. The base station may be configured to perform the steps of the method according to the first aspect, and the terminal may be configured to perform the steps of the method according to the second aspect.

According to a fourteenth aspect, a readable storage medium is provided. The readable storage medium stores a program or an instruction, and the program or the instruction is executed by a processor to implement the steps of the method according to the first aspect, the second aspect, or the third aspect.

According to a fifteenth aspect, a chip is provided. The chip includes a processor and a communication interface. The communication interface is coupled to the processor, and the processor is configured to run a program or an instruction to implement the method according to the first aspect, the second aspect, or the third aspect.

According to a sixteenth aspect, a computer program/program product is provided. The computer program/program product is stored in a storage medium, and the computer program/program product is executed by at least one processor to implement the steps of the method according to the first aspect, the second aspect, or the third aspect.

In the embodiments of this application, the first device determines the first condition for selecting the sensing terminal, where the first condition is related to the geographical location requirement for the sensing terminal to participate in the sensing, and/or the measurement quantity value requirement corresponding to the geographical location requirement. In this way, a terminal fulfilling the condition may be determined according to the first condition.

### BRIEF DESCRIPTION OF DRAWINGS

FIG. 1 is a block diagram of a wireless communication system to which embodiments of this application may be applied;

FIG. 2 is a first flowchart of a sensing terminal selection method according to an embodiment of this application;

FIG. 3 is a schematic diagram of a TDOA positioning principle;

FIG. 4 is a schematic diagram of an RTT positioning principle;

FIG. 5 is a schematic diagram of an angle-based positioning principle;

FIG. 6 is a second flowchart of a sensing terminal selection method according to an embodiment of this application;

FIG. 7 is a third flowchart of a sensing terminal selection method according to an embodiment of this application;

FIG. 8 is a flowchart of a sensing terminal selection method according to Embodiment 1 of this application;

FIG. 9 is a flowchart of a sensing terminal selection method according to Embodiment 2 of this application;

FIG. 10 is a flowchart of a sensing terminal selection method according to Embodiment 3 of this application;

FIG. 11 is a flowchart of a sensing terminal selection method according to Embodiment 4 of this application;

FIG. 12 is a first schematic diagram of a structure of a sensing terminal selection apparatus according to an embodiment of this application;

FIG. 13 is a second schematic diagram of a structure of a sensing terminal selection apparatus according to an embodiment of this application;

FIG. 14 is a third schematic diagram of a structure of a sensing terminal selection apparatus according to an embodiment of this application;

FIG. 15 is a schematic diagram of a structure of a communication device according to an embodiment of this application;

FIG. 16 is a schematic diagram of a hardware structure of a terminal according to an embodiment of this application; and

FIG. 17 is a first schematic diagram of a hardware structure of a network side device according to an embodiment of this application; and

FIG. 18 is a second schematic diagram of a hardware structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th Generation (6G) communication system.

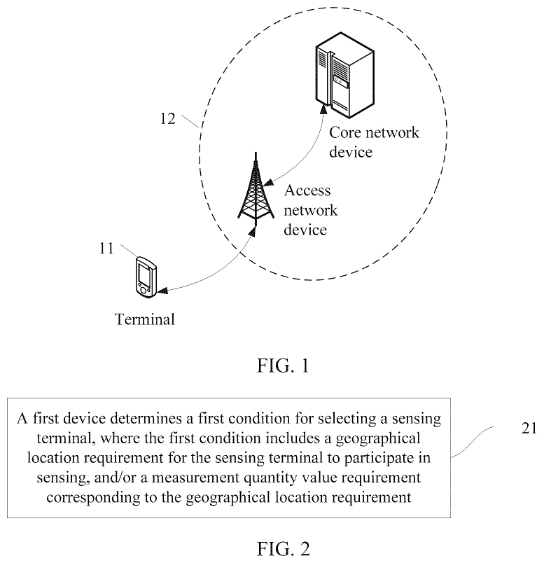

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a wireless network communications technology (Wireless Fidelity, Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the field. As long as a same technical effect is achieved, the base station is not limited to a specified technical term. It should be noted that, in the embodiments of this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a local NEF (Local NEF or L-NEF), a Binding Support Function (BSF), an Application Function AF), or the like. It should be noted that, in the embodiments of this application, only a core network device in an NR system is used as an example for description, and a specific type of the core network device is not limited.

A sensing terminal selection method and apparatus and a communication device provided in the embodiments of this application are described in detail below with reference to the accompanying drawings by using some embodiments and application scenarios thereof.

To better understand the embodiments of this application, some related technical points are first described below:

### (1) Integrated Sensing and Communication

Integrated sensing and communication means that in a same system, a design of integrated communication and sensing functions is implemented through spectrum sharing and hardware sharing. When information is transmitted, the system can sense information such as a direction, a distance, and a speed, and detect, track, and identify a target device or an event. A communication system and a sensing system cooperate with each other, to improve overall performance and bring better service experience.

In addition to a communication capability, a future mobile communication system, for example, a beyond 5^{th} generation (B5G) mobile communications system or a 6G system, is about to have a sensing capability. The sensing capability is that one or more devices with the sensing capability can sense information such as a direction, a distance, and a speed of a target object by sending and receiving a radio signal, or detect, track, identify, or image a target object, an event, an environment, or the like. In the future, with the deployment of a small base station with a capability of a high frequency band and high bandwidth such as millimeter wave and terahertz in a 6G network, resolution of sensing is significantly improved when compared with that of a centimeter wave, so that the 6G network can provide a more precise sensing service. A typical sensing function and an application scenario are shown in Table 1.

TABLE 1

| Communication | | |
|---|---|---|
| sensing category | Sensing function | Application scenario |
| Macro sensing | Weather conditions, air quality, and the | Meteorology, agriculture, and |
| type | like | life services |
| | Traffic flow (intersections) and flow of | Intelligent traffic and |
| | people (subway entrances) | commercial services |
| | Target tracking, ranging, speed | Many application scenarios for |
| | measurement, contours, and the like | conventional radars |
| | Environment reconstruction | Intelligent driving and |
| | | navigation (car/uncrewed aerial |
| | | vehicles), smart city (three- |
| | | dimensional (3D) map), and |
| | | network planning and |
| | | optimization |
| Fine sensing type | Action/posture/expression recognition | Intelligent interaction of |
| | | smartphones, games, and smart |
| | | home |
| | Heartbeat/breathing and the like | Health and medical care |
| | Imaging, material detection, component | Security inspection, industry, |
| | analysis, and the like | biological medicine, and the like |

Descriptions of quality of service requirements of the sensing service are different. For example, sensing such as intelligent traffic or a high-precision map is generally expressed by a sensing range, distance resolution, angle resolution, speed resolution, and a delay. Flight intrusion detection sensing is usually expressed by coverage height, sensing accuracy, and a sensing delay. Respiration monitoring is expressed by a sensing distance, a sensing real-time characteristic, sensing resolution, and sensing accuracy. Indoor intrusion detection is expressed by a sensing distance, sensing real-time performance, a detection probability, and a false alarm probability. Gesture/posture recognition is expressed by a sensing distance, sensing real-time performance, and sensing accuracy.

Service request manners of the foregoing sensing services are different. For example, for a static area-based service request, a coordinate system represents a geographical location area requiring sensing content; for a dynamic area-based service request, M meters around a UE represent a geographical location range requiring sensing content; and for a continuous sensing service request for a dynamic target, a detected and continuously tracked target represents a sensing target requiring sensing content.

Currently, positioning methods supported by 5G include a Downlink Time Difference Of Arrival (DL-TDOA) method, an uplink time difference of arrival (UL-TDOA) method, a multi-cell round-trip time (Multi-RTT) method, a downlink angle-of-departure (DL-AOD) method, an uplink angle-of-arrival (UL-AOA), and an NR enhancement cell identifier (E-CID) positioning method.

In a 5G positioning-related scenario, a clear UE ID is present, so that an LMF and a base station may accurately find and interact with this UE based on the UE ID. Whether a UE is required to participate in sensing and which UEs are suitable for participation usually need to be determined with reference to multiple pieces of information (such as a UE location, UE sensing authorization information, and UE sensing capability information). For the service sensing requests in the following three cases, in a case that the UE is required for participation, in a process of sensing service initiation and continuous sensing, how to select an appropriate sensing terminal by a network functions is a problem to be resolved:

Case 1: For the static area-based service request, for example, the coordinate system represents the geographical location area requiring the sensing content.

Case 2: For the dynamic area-based service request, for example, the M meters around the UE represent the geographical location range requiring the sensing content.

Case 3: For the continuous sensing service request for the dynamic target, for example, the detected and continuously tracked target represents the sensing target requiring the sensing content.

Further, one of important factors in selecting an appropriate UE is location information of the UE. How a network can know specific Us at some locations suitable for sending or receiving a sensing signal in a sensing area is a problem to be resolved. In addition to the location information, UE selection also needs to consider a sensing capability of the UE, an orientation of the UE, a motion state (static or motion speed) of the UE, willingness of the UE to participate in sensing, and the like. In a case that the foregoing information is sent to the UE through a system broadcast message, there may be two potential problems: First, it leads to a lot of broadcast content, and second, it may not be accurate enough for the UE to autonomously determine whether multiple sensing conditions are fulfilled (for example, it is difficult to obtain accurate Global Positioning System (GPS) positioning information when the UE is in an indoor environment, which may lead to inaccurate location determining). Then, the geographical location information of the UE is required as label data for some sensing measurement quantities in a process of calculating sensing results from the sensing measurement quantities. Therefore, in a case that the UE is required to participate in the foregoing sensing scenario, how the network efficiently knows specific UEs supporting sensing and location information of the UEs in a sensing-related area is a problem to be resolved.

Refer to FIG. 2. An embodiment of this application provides a sensing terminal selection method. The method includes the following steps.

Step 21: A first device determines a first condition for selecting a sensing terminal, where the first condition includes a geographical location requirement for the sensing terminal to participate in sensing, and/or a measurement quantity value requirement corresponding to the geographical location requirement.

The first device may be a sensing function node or a base station, which is described in detail in the following embodiments.

In this embodiment of this application, the first device determines the first condition for selecting the sensing terminal, where the first condition is related to the geographical location requirement for the sensing terminal to participate in the sensing, and/or the measurement quantity value requirement corresponding to the geographical location requirement. In this way, a terminal fulfilling the condition may be determined according to the first condition, to resolve a problem that a network side cannot know the terminal suitable for sensing in a sensing area.

In this embodiment of this application, that a first device determines a first condition for selecting a sensing terminal includes: The first device determines whether a terminal is required to participate in sensing; and in a case that the first device determines that the terminal is required to participate in the sensing, the first device determines the first condition for selecting the sensing terminal.

In this embodiment of this application, that the first device determines whether a terminal is required to participate in sensing includes: The first device determines, based on at least one of a first sensing request or sensing capability information of a network function that are received, whether the terminal is required to participate in the sensing.

The first sensing request includes at least one of the following:
a sensing target area: is a location area in which a sensing object may be present, or a location area that requires imaging or three-dimensional reconstruction;
a sensing object type: a sensing object is classified according to a possible motion characteristic of the sensing object, and each sensing object type includes information such as a motion speed, motion acceleration, and a typical Radar Cross section (RCS) of a typical sensing object;
a sensing target object: in a case that one or more sensing target objects are sensed, identification information of the sensing object is provided, and potential identification manners include characteristic identification on a distance, a speed, and an angle spectrum, or identification based on a UE ID that may be identified by a network; or
sensing Quality of Service (QOS): a performance indicator for sensing the sensing target area or the sensing object includes at least one of the following: sensing resolution (which may further include at least one of ranging resolution, angle measurement resolution, speed measurement resolution, and imaging resolution), sensing precision (which may further include at least one of ranging precision, angle measurement precision, speed measurement precision, positioning precision, and the like), a sensing range (which may further include at least one of a ranging range, a speed measurement range, a speed measurement range, an imaging range, and the like), a sensing delay (which is a time interval from sending of a sensing signal to obtaining of a sensing result, or a time interval from initiating of a sensing requirement to obtaining of a sensing result), a sensing update rate (which is a time interval at which two consecutive times of executing sensing and obtaining a sensing result), a detection probability (which is a probability of correctly detecting a sensing object in a case that the sensing object is present), and a false alarm probability (which is a probability of incorrectly detecting a sensing object in a case that the sensing object is absent).

The sensing capability information of the network function includes at least one of the following: a sensing range of a base station, a sensing range of an AMF, information about a sensing service supported by the base station, or information about a sensing service supported by the AMF.

In this embodiment of this application, that the terminal is required to participate in the sensing includes at least one of the following: the terminal is required to send a sensing signal, the terminal is required to receive a sensing signal and perform sensing measurement, the terminal is required to send sensing assistance information, or the terminal is required to process a sensing measurement result.

In this embodiment of this application, the measurement quantity value requirement includes at least one of the following:
(1) an uplink received signal strength measurement value requirement and/or a downlink Received Signal Strength (RSS) measurement value requirement; where
the uplink received signal strength measurement value requirement is a receiving bandwidth power of a base station, including thermal noise within a bandwidth defined by a filter formed in receiver pulses and noise generated by a receiver; and a measurement reference point is an antenna port, and an RSS is an average value of powers of all signals (including a pilot signal, a data signal, an interference signal, a noise signal, and/or the like) received in specific time (such as one symbol); and
the downlink received signal strength measurement value requirement is a receiving bandwidth power of a terminal, including thermal noise within a bandwidth defined by a filter formed in receiver pulses and noise generated by a receiver; and a measurement reference point is an antenna port, and an RSS is an average value of powers of all signals (including a pilot signal, a data signal, an interference signal, a noise signal, and/or the like) received in specific time (such as one symbol); and
(2) a Signal-to-noise Ratio (SNR) requirement; where
this parameter is a ratio of a strength of a wanted signal received by the terminal or the base station to a strength of received noise;
(3) an uplink reference signal received power measurement value requirement and/or a downlink Reference Signal Received Power (RSRP) measurement value requirement; where
this parameter is an average value of reference signal powers in a measurement frequency band, and an RSRP is an average value of powers of signals received in specific time (such as one symbol) on all resources for carrying a reference signal;
(4) an uplink reference signal received quality measurement value requirement and/or a downlink Reference Signal Received Quality (RSRQ) measurement value requirement; where
this parameter is a ratio of the RSRP and the RSS, and in a case that an RSRP measurement bandwidth and an RSS measurement bandwidth are different, a coefficient is required for adjustment, such as RSRQ=N×RSRP/RSS, where N indicates a quantity of Resource block (RB) in the RSS measurement bandwidth;
(5) a Channel Impulse Response (CIR) measurement value requirement; where
this parameter is a complex-number result of a channel response;
(6) an uplink reference signal time difference measurement value requirement and/or a downlink Reference Signal Time Difference (RSTD) measurement value requirement; where
this parameter is a time difference of a received signal arriving at multiple TRPs;
(7) a Round-Trip Time (RTT) measurement value requirement between a base station and a terminal; where
assuming that time for a node 1 to send a signal is to, time for a node 2 to receive the signal is t1, time for the node 2 to send a signal is t2, and time for the node 1 to receive the signal is t3, RTT=t1−t0+t3−t2=(t3−t0)+ (t1−t2);
(8) an uplink Angle-of-Arrival (AoA) measurement value requirement; where
this parameter is used to measure an angle, and is usually applied in a multi-antenna system to measure an angle-of-arrival of a beam; and
(9) a downlink angle-of-departure measurement value requirement; where
this parameter is used to measure an angle, and is usually applied in the multi-antenna system to measure an angle-of-departure of the beam.

In this embodiment of this application, the geographical location requirement is a geographical location coordinate value requirement that is based on a coordinate system, such as O is used as an origin coordinate value (X, Y, Z) and a deviation in any direction of X, Y, or Z is less than 0.5 m; or a coordinate value requirement represented by longitude, latitude, and height.

In this embodiment of this application, the measurement quantity value requirement includes a measurement value requirement on the terminal for a downlink signal of one or more base stations, and/or a measurement value requirement on the one or more base stations for an uplink signal of the terminal. For example, the measurement value requirement for the downlink signal is as follows: Received signal strengths of the UE for a cell 1, a cell 2, and a cell 3 are −60 dbm, −70 dbm, and −80 dbm respectively, and a deviation value is less than 3 dbm. Conversely, in an uplink direction, the cell 1, the cell 2 and the cell 3 have a received strength measurement value requirement for the uplink signal of the UE.

In this embodiment of this application, in the multi-antenna system, the measurement quantity value requirement includes a measurement value requirement for a signal of one or more beams.

The foregoing measurement quantity requirement is determined according to a used positioning method. The following briefly describes related positioning methods.

Currently, positioning methods supported by 5G include a Downlink Time Difference Of Arrival (DL-TDOA) method, an uplink time difference of arrival (UL-TDOA) method, a multi-cell round-trip time (Multi-RTT) method, a downlink angle-of-departure (DL-AOD) method, an uplink angle-of-arrival (UL-AOA), and an NR enhancement cell identifier (E-CID) positioning method.

### (2a) Downlink Time Difference of Arrival (DL-TDOA) Method

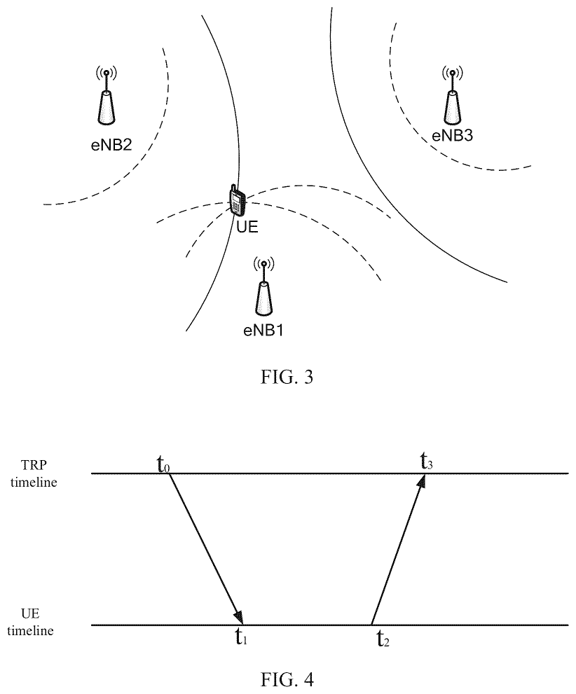

As shown in FIG. 3, the UE obtains relative time of arrival of downlink (DL) Positioning Reference Signal (PRS) of multiple TRPs (an eNB 1, an eNB 2, and an eNB 3), that is, a Reference Signal Time Difference (RSTD). Then, the UE or the LMF solves geographical coordinates of the UE according to an appropriate location solving algorithm. Through DL-TDOA measurement, an equation set may be obtained:

$${R}_{i , 1} = c ( {t}_{i} - {t}_{1} ) = {R}_{i} - {R}_{1}$$

$${R}_{i} = \sqrt{{( {x}_{i} - {x}_{0} )}^{2} + {( {y}_{i} - {x}_{0} )}^{2}} i = 1 , 2 … , N$$

Rᵢ is a distance from an i^{th} TRP to the UE.

(xᵢ, yᵢ) is coordinates of the i^{th} TRP, and (x₀, y₀) is coordinates of the UE.

N is a quantity of TRPs, c is the speed of light, and tᵢ−t₁ is a time difference of arrival between the i^{th} TRP and a 1^{st} TRP.

A time difference of arrival (time difference of arrival (Time Difference Of Arrival, TDOA) or RSTD) of two TRPs may determine the UE on a hyperbola. Three TRPs may define the UE to an area. In NR, the UE may measure and report up to RSTDs of 256 TRPs.

### (2b) UL-TDOA Positioning Method

In the UL-TDOA positioning method, the LMF estimates a location of the UE based on an UL-RTOA measurement result of a UE uplink positioning reference signal (SRS for positioning) measured at different TRPs and other configuration information. The UE does not need to participate in positioning measurement and calculation. A positioning principle thereof is the same as that of DL-TDOA, and quality of the uplink signal cannot be guaranteed due to a low transmit power of the UE reference signal. Therefore, the UE cannot ensure that a surrounding base station may correctly parse the uplink reference signal of the UE, which limits a quantity of nodes participating in positioning, resulting in a decline in location precision.

### (2c) Multi-Cell Round-Trip Time (Multi-RTT) Method

In LTE, the RTT positioning method has been used in an E-CID technology to estimate a distance between the base station and the UE. In NR, single RTT is extended to RTT between multiple cells and the UE, that is, multi-RTT. RTT measurement results between multiple base stations and the UE are used to jointly estimate the location of the UE. As shown in FIG. 4, RTT=(t3−t0)+(t1−t2).

Compared with the TDOA-based positioning technology, multi-RTT has an advantage that strict synchronization between base stations is not required, that is, multi-RTT is not affected by a synchronization error between TRPs. Multi-RTT precision is mainly limited by uplink coverage.

### (2d) Angle-Based Positioning Method

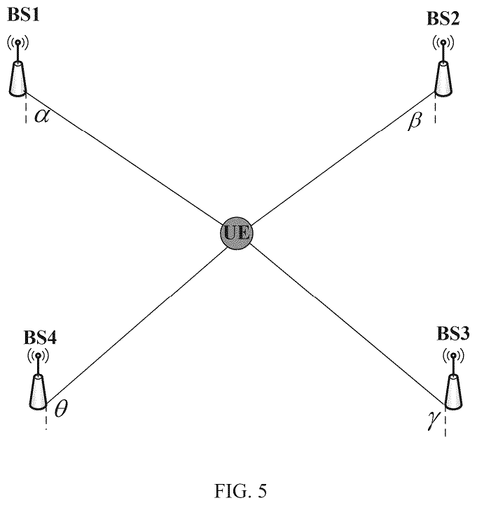

Downlink angle-of-departure (DL-AOD) and uplink angle-of-arrival (UL-AOA) both belong to angle-based positioning methods. Refer to FIG. 5. A principle of the angle-based positioning technology is that measurement angles of at least two base stations are used to estimate the location of the UE. The base station usually has a much larger quantity of antennas than the UE, and angle measurement precision is higher. Therefore, in NR, a measurement angle on a base station side is selected, that is, the downlink angle-of-departure DL-AOD positioning technology and the uplink angle-of-arrival UL-AOA positioning technology are introduced. For the DL-AoD, the DL angle-of-departure is determined based on a DL PRS-RSRP and PRS beam information (such as a beam direction) that are measured by the UE, to further determine the location of the UE. For the UL-AoA, the UL AoA is measured by a next generation NodeB (the next Generation NodeB, gNB), to further determine the location of the UE.

In this embodiment of this application, that a first device determines a first condition for selecting a sensing terminal includes:

The first device determines the geographical location requirement for the sensing terminal to participate in the sensing.

The first device determines the measurement quantity value requirement corresponding to the geographical location requirement.

In this embodiment of this application, the geographical location requirement includes at least one of the following:
(1) a geographical location at which a terminal is required to participate in sensing in a case that a sensing manner is that a base station sends a sensing signal and the terminal receives the sensing signal and performs sensing measurement; where
for example, a base station A (in a case that the sensing target area requires cooperation of multiple base stations, it can be extended to a case of the multiple base stations herein) sends a sensing signal, used for a location area of a UE receiving the sensing signal and measurement;
(2) a geographical location at which a terminal is required to participate in sensing in a case that a sensing manner is that the terminal sends a sensing signal and a base station receives the sensing signal and performs sensing measurement; where
for example, a base station A (in a case that the sensing target area requires cooperation of multiple base stations, it can be extended to a case of the multiple base stations herein) receives a sensing signal and measurement, used for a location area of a UE sending the sensing signal;
(3) a geographical location at which a terminal is required to participate in sensing in a case that a sensing manner is that the terminal sends a sensing signal and the terminal receives the sensing signal and performs sensing measurement; or
(4) a geographical location at which a terminal is required to participate in sensing in a case that a sensing manner is that the terminal sends a sensing signal and another terminal receives the sensing signal and performs sensing measurement.

In this embodiment of this application, the first device determines the geographical location requirement according to the sensing target area and the sensing range of the base station in the first sensing request information.

In this embodiment of this application, the first device may determine, according to a radio frequency fingerprint database, the measurement quantity value requirement corresponding to the geographical location requirement. In some embodiments, another manner of determining the measurement quantity value requirement corresponding to the geographical location requirement is not excluded.

The radio frequency fingerprint database is applied in a radio frequency fingerprint positioning method. The radio frequency fingerprint positioning method has become one of commonly used indoor positioning methods due to its good positioning performance, high precision, and easy reuse of existing hardware to implement a radio frequency measurement quantity (such as a received signal power, a signal-to-noise ratio, and the like). The radio frequency fingerprint positioning method is usually divided into two stages: an offline stage and an online stage. At the offline stage, a fingerprint database consisting of sampling point coordinates and a received signal characteristic is constructed, and location coordinates have a one-to-one correspondence with the received signal characteristic (in a cellular network, the fingerprint database is usually constructed by a measurement quantity and location information reported by a UE in the network for long time, such as Minimization of Drive Tests (MDT), operator-owned application (APP) information, or manual measurement). At the online stage, according to a real-time signal characteristic received by a user at a location, a matching algorithm is used to match the real-time signal characteristic with a fingerprint in the fingerprint database. After the matched fingerprint is found, sampling point coordinates corresponding to the matched fingerprint is considered to be a location of the mobile user. At the offline stage, a relationship function between location coordinates and a signal characteristic in the fingerprint database can also be learned by using a machine learning algorithm. At the online stage, the real-time signal characteristic can be brought into the relationship function to obtain coordinate estimation of the mobile user. A radio signal characteristic value used to mark a location is referred to as a radio frequency fingerprint or a radio fingerprint, and a fingerprint positioning method using a radio frequency signal is referred to as the radio frequency fingerprint positioning method. A basic principle of the radio frequency fingerprint positioning method is based on a correspondence between two-dimensional or three-dimensional location space and n-dimensional fingerprint signal space.

In this embodiment of this application, the first device is a sensing function node, and after that a first device determines a first condition for selecting a sensing terminal, the method further includes: The sensing function node sends a second sensing request to a base station, where the second sensing request includes the first condition and an identifier of a second device for receiving a sensing response, and the second sensing request is broadcast by the base station. In a case that the sensing function node needs to send the first condition, because it is not clear which terminals are sensing terminals, the sensing function node usually needs to send the first condition to one or more base stations according to the determined first condition. That is, the second sensing request message is a non-UE associated message, namely, a global message. In a case that a protocol stack between the sensing function and the base station is forwarded by an AMF, a same manner is used for the message, but a next generation application protocol (NG Application Protocol, NGAP) message (that is, a protocol stack message between a core network and the base station) that carries the message is a non-UE associated message, that is, does not carry a UE NGAP ID (that is, a RAN UE NGAP ID) allocated by the base station. In a case that a protocol stack between the sensing function and the base station does not require forwarding of an AMF, the message may be sent directly by the sensing function to the corresponding base station. After receiving the first condition, the base station sends the first condition in a broadcast manner rather than sending the first condition to a specified terminal. In some embodiments, in a case that the sent geographical location information is related to a base station coverage area, one base station is determined to send the first condition. In a case that the measurement quantity value requirement is sent, there are usually measurement value requirements on multiple base stations, and therefore a measurement value requirement on a base station may be sent to the base station.

In this embodiment of this application, the second device and the first device may be a same device or different devices.

In this embodiment of this application, after that the sensing function node sends a second sensing request to a base station, the method further includes:

The sensing function node receives a sensing response sent by a terminal for the second sensing request.

The sensing function node determines the sensing terminal according to the sensing response.

The sensing response includes at least one of the following:
(1) an identifier of the terminal; where
the identifier is an identifier that may be identified by the second device, for example, in a case that the second device is a core network sensing function, the identifier may be a core network identifier of the UE, such as a Subscription Permanent Identifier (SUPI); in a case that the second device is a base station, the identifier may be a Radio Network Temporary Identity (RNTI) (cell radio network temporary identity (Cell RNTLC-RNTI) or an inactive RNTI (Inactive RNTLI-RNTI)), a RAN-UE-NGAP-ID, or the like; and in a case that the terminal is in an idle state, the foregoing identifier needs to be reported; or in a case that the terminal is in a connected state, the foregoing identifier does not need to be reported;
(2) indication information indicating that the terminal is willing to participate in sensing;
(3) a measurement quantity value fulfilling the first condition; where for example, measured received signal strength values of multiple TRPs; or
(4) assistance information for assisting in selecting the sensing terminal.

In this embodiment of this application, the assistance information includes at least one of the following: an orientation of the terminal, a speed of the terminal, duration for the terminal to maintain a current motion state (that is, time for maintaining the motion state unchanged such as a current location, a current orientation, and/or a current speed), location information of the terminal in future preset time, and another terminal identifier recommended by the terminal, where the another terminal identifier recommended is an identifier of another terminal that cooperates with the terminal for sensing in a case that a sensing manner is that a sensing signal is sent and received between terminals.

The sensing function node may receive sensing responses from multiple terminals. The sensing function node may query a sensing capability and authorization information of a terminal according to identification information of the terminal to obtain specific sensing services supported and authorized by the terminal, and therefore determine the sensing terminal.

In some embodiments, the sensing function node may obtain the geographical location information of the terminal according to a measurement result in the sensing response, to assist in determining the terminal; or initiate a positioning procedure to the terminal based on the UE ID to obtain the geographical location information of the terminal; or determine the sensing terminal based on other assistance information provided by the terminal.

In some embodiments of this application, the first device is a sensing function node, and after that a first device determines a first condition for selecting a sensing terminal, the method further includes:

The sensing function node sends a second sensing request to a base station, where the second sensing request includes the first condition. The base station determines a candidate sensing terminal list according to the second sensing request.

In this embodiment of this application, the second sensing request further includes a candidate sensing terminal quantity indication and/or an identifier of a second device for receiving a sensing response. In this embodiment of this application, after that the sensing function node sends a second sensing request to a base station, the method further includes:

The sensing function node receives a sensing response sent by the base station for the second sensing request.

The sensing function node determines the sensing terminal according to the sensing response.

The sensing response includes at least one of the following:
(1) a candidate sensing terminal list; where the candidate sensing terminal list includes an identifier of at least one terminal; and
(2) a measurement quantity value fulfilling the first condition; where for example, measured received signal strength values of multiple TRPs; or
(3) assistance information for assisting in selecting the sensing terminal.

In this embodiment of this application, the assistance information includes communication load information of a candidate terminal, for example, a quantity of UE uplink/downlink communication RBs and a UE uplink/downlink throughput.

In some embodiments of this application, the first device is a base station, and after that a first device determines a first condition for selecting a sensing terminal, the method further includes:

The base station determines a candidate sensing terminal list according to the first condition.

In this embodiment of this application, after that the base station determines a candidate sensing terminal list according to the first condition, the method further includes:

The base station sends a third sensing request to a terminal in the candidate sensing terminal list, where the third sensing request is used to request the terminal to participate in sensing.

The base station receives a sensing response of the terminal for the third sensing request, where the sensing response indicates whether the terminal agrees to participate in the sensing.

The base station determines the target sensing terminal list according to the sensing response.

In this embodiment of this application, the third sensing request includes sensing information, and the sensing information includes at least one of the following: cost information for participating in sensing or estimated sensing duration.

In this embodiment of this application, that the base station determines a candidate sensing terminal list according to the first condition includes:

In a case that the first condition includes a measurement quantity value requirement for an uplink signal, the base station determines the candidate sensing terminal list according to the first condition.

In some embodiments, in a case that the first condition includes a measurement quantity value requirement for a downlink signal, the base station sends a fourth sensing request to a terminal, where the fourth sensing request includes the first condition.

The base station receives a sensing response of the terminal for the fourth sensing request, where the sensing response includes at least one of the following: an identifier of the terminal, indication information indicating that the terminal is willing to participate in sensing, a measurement quantity value fulfilling the first condition, or assistance information for assisting in selecting the sensing terminal.

The base station determines the candidate sensing terminal list according to the sensing response.

In some embodiments, in a case that the first condition includes a measurement quantity value requirement for an uplink signal and a measurement quantity value requirement for a downlink signal, the base station determines a candidate sensing terminal according to the measurement quantity value requirement for the uplink signal in the first condition.

The base station sends a fourth sensing request to a terminal, where the fourth sensing request includes the first condition.

The base station receives a sensing response of the terminal for the fourth sensing request, where the sensing response includes at least one of the following: an identifier of the terminal, indication information indicating that the terminal is willing to participate in sensing, a measurement quantity value fulfilling the first condition, or assistance information for assisting in selecting the sensing terminal.

The base station determines the candidate sensing terminal list according to the sensing response and the candidate sensing terminal determined by the base station.

In some embodiments of this application, after that the base station determines a candidate sensing terminal list according to the first condition, the method further includes: The base station determines the sensing terminal according to the candidate sensing terminal list.

In some embodiments of this application, after that the base station determines a candidate sensing terminal list according to the first condition, the method further includes: The base station sends the candidate sensing terminal list to a sensing function node. The sensing function node determines the sensing terminal according to the candidate sensing terminal list.

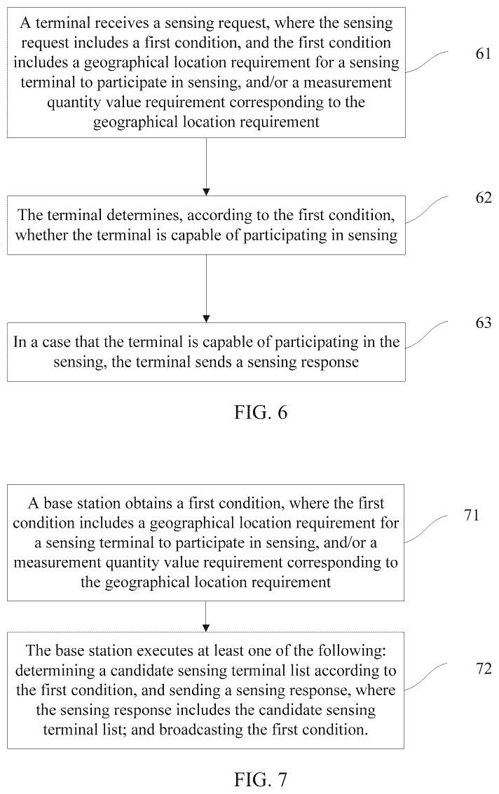

Refer to FIG. 6. An embodiment of this application further provides a sensing terminal selection method. The method includes the following steps.

Step 61: A terminal receives a sensing request, where the sensing request includes a first condition, and the first condition includes a geographical location requirement for a sensing terminal to participate in sensing, and/or a measurement quantity value requirement corresponding to the geographical location requirement.

Step 62: The terminal determines, according to the first condition, whether the terminal is capable of participating in sensing.

Step 63: In a case that the terminal is capable of participating in the sensing, the terminal sends a sensing response.

In this embodiment of this application, the terminal receives the first condition for selecting the sensing terminal, determines, according to the first condition, whether the condition is fulfilled, and reports to a network side, to resolve a problem that the network side cannot know a terminal suitable for sensing in a sensing area.

In this embodiment of this application, the measurement quantity value requirement includes at least one of the following:
a downlink received signal strength measurement value requirement;
a signal-to-noise ratio requirement;
a downlink reference signal received power measurement value requirement;
a downlink reference signal received quality measurement value requirement;
a downlink reference signal time difference measurement value requirement; or
a downlink angle-of-departure measurement value requirement.

In this embodiment, a UE autonomously determines whether the first condition is fulfilled, and therefore the first condition is a measurement quantity value requirement for a downlink signal on a UE side.

In this embodiment of this application, the measurement quantity value requirement includes a measurement value requirement for a downlink signal of one or more base stations.

In this embodiment of this application, the measurement quantity value requirement includes a measurement value requirement for a signal of one or more beams.

In this embodiment of this application, the sensing request further includes an identifier of a second device for receiving the sensing response and/or a candidate sensing terminal quantity indication. That the terminal sends a sensing response includes: The terminal sends the sensing response to the second device for receiving the sensing response.

In this embodiment of this application, that a terminal receives a sensing request includes: The terminal receives the sensing request sent by a base station, where the sensing request is carried in a paging message, a cell system message, or a dedicated Radio Resource Control (RRC) message.

In this embodiment of this application, that the terminal determines, according to the first condition, whether the terminal is capable of participating in sensing includes:
The terminal determines, according to a result of currently completed downlink signal measurement, whether the first condition is fulfilled; or
the terminal measures a downlink signal according to the first condition, and determines, according to a measurement result, whether the first condition is fulfilled.

In this embodiment of this application, that the terminal determines, according to the first condition, whether the terminal is capable of participating in sensing includes:
In a case that the first condition is fulfilled, the terminal determines that the terminal is capable of participating in the sensing; or
in a case that the first condition is fulfilled, the terminal determines, according to a status of the terminal, whether the terminal is capable of participating in the sensing.

In this embodiment of this application, the sensing request further includes sensing information, and the sensing information includes at least one of the following: cost information for participating in sensing or estimated sensing duration.

That the terminal determines, according to a status of the terminal, whether the terminal is capable of participating in the sensing includes: The terminal determines, according to the sensing information, whether the terminal is capable of participating in the sensing. That is, the terminal that fulfills the first condition may have a degree of autonomy, and may determine, according to the status of the terminal, whether to send a sensing response message, such as sensing cost information and a power status. For example, in a case that power of the terminal is low or sensing costs are lower than a threshold, the terminal may still determine not to send the sensing response message even if the first condition is fulfilled.

In this embodiment of this application, the sensing response may be an RRC message, such as a UE assistance information message, similar to MDT, indicating an Internet Protocol (IP) address of a target receiver of the message.

In this embodiment of this application, the sensing response includes at least one of the following:
an identifier of the terminal; where the identifier is an identifier that may be identified by the second device;
indication information indicating that the terminal is willing to participate in sensing;
a measurement quantity value fulfilling the first condition; or
assistance information for assisting in selecting the sensing terminal.

The assistance information may include an orientation of the terminal, a speed of the terminal, duration for the terminal to maintain a current motion state (that is, time for maintaining the motion state unchanged such as a current location, a current orientation, and a current speed), and/or the like. In a case that a future location of the terminal is known or predictable, the terminal may provide location information for a time period in the future. When the terminal supports receiving and receiving sensing between terminals, in a case that the terminal recommends another sensing terminal that may cooperate with the terminal, the terminal may provide an identifier of the another sensing terminal recommended.

In this embodiment of this application, before that the terminal sends a sensing response, the method further includes: In a case that the terminal is in an idle state or inactive state, the terminal initiates an RRC connection establishment request or an RRC connection resume request to enter a connection state, where a reason for the terminal to initiate the RRC connection establishment request or the RRC connection resume request is to respond to the sensing request.

Definitions of related RRC states and switching between the RRC states are described below.

5G RRC has three states: an idle state, an inactive state, and a connected state.

In the idle state, no RRC connection is established between a UE and a base station, and the base station does not have a RRC context of the UE. From a perspective of a core network, a connection between a RAN side and the core network is broken. To reduce power consumption, the UE is in a sleep state most of the time, and therefore data transmission cannot be performed. The UE may wake up periodically to receive a paging message (if present) from a network. When the UE receives the paging message sent to the UE or has uplink data to send, the UE initiates a random access procedure and establishes an RRC connection to switch from the idle state to the connected state. The UE in the idle state camps on a serving cell. As the UE moves, the camped serving cell is changed by using a cell reselection mechanism.

In the connected state, connections are established between the UE and the base station, and between the base station and the core network. The base station stores the RRC context for the UE. The UE may transmit uplink and downlink data with the base station. In the connected state, mobility may be controlled by the network side, that is, the UE provides neighboring cell measurement for the network, and the network instructs the device to perform handover.

In LTE, only the idle state and the connected state are supported. However, due to frequent transmission of small data packets in some smart phones, a large amount of switching between the idle state and the connected state is present in a case that an LTE manner is followed. These switching increases signaling load and a signaling delay. Therefore, to reduce the signaling load and waiting time, the inactive state is introduced in NR.

In the inactive state, the RRC connection between the UE and the base station is released, and a last serving base station stores the RRC context of the UE and maintains the connection to the UE of the core network. The inactive state is transparent to the core network. That is, the UE is still in the connected state from the perspective of the core network. When enabling the UE to enter the inactive state, the base station configures a radio notification area (RAN-based Notification Area, RNA) area for the UE. The UE may move between cells within the RNA area without notifying the network. Therefore, when the network requires the UE to enter the connected state, the network pages the UE in all cells within the RNA area. Switching from the inactive state to the connected state is very fast, and core network signaling is not required. In addition, the UE is allowed to sleep in a manner similar to the idle state, and mobility is processed through cell reselection. Therefore, the inactive state may be considered as a mixture of the idle state and the connected state.

The foregoing RRC states are states between the UE and the base station. There is a connection management state (CM state) between the UE and the core network (AMF), including a CM-IDLE state and a CM-CONNECTED state. When the UE is in the CM-IDLE state, N2 and N3 connections of the terminal are absent. On an air interface, a corresponding UE state is the idle state. A non-access stratum (NAS) signaling connection is established between the UE in the CM-CONNECTED state and the corresponding AMF. On the air interface, the corresponding UE state is the connected state or the inactive state.

Refer to FIG. 7. An embodiment of this application further provides a sensing terminal selection method. The method includes the following steps.

Step 71: A base station obtains a first condition, where the first condition includes a geographical location requirement for a sensing terminal to participate in sensing, and/or a measurement quantity value requirement corresponding to the geographical location requirement.

Step 72: The base station executes at least one of the following:
determining a candidate sensing terminal list according to the first condition, and sending a sensing response, where the sensing response includes the candidate sensing terminal list; or
broadcasting the first condition.

In this embodiment of this application, the candidate sensing terminal list may be formed by a UE network identifier (such as a RAN-UE-NGAP ID).

In this embodiment of this application, the base station obtains the first condition, and determines, according to the first condition, the candidate sensing terminal, or broadcasts the first condition, and the terminal determines whether to participate in sensing, to resolve a problem that a network side cannot know a terminal suitable for sensing in a sensing area.

In this embodiment of this application, that a base station obtains a first condition includes: The base station receives a sensing request, where the sensing request includes the first condition, the sensing request is sent by a sensing function node.

In some other embodiments of this application, that a base station obtains a first condition includes: The base station receives a sensing request, and determines the first condition according to the sensing request. In some embodiments, the sensing request is sent by a sensing function node.

In this embodiment of this application, the measurement quantity value requirement includes at least one of the following:
an uplink received signal strength measurement value requirement and/or a downlink received signal strength measurement value requirement;
a signal-to-noise ratio requirement;
an uplink reference signal received power measurement value requirement and/or a downlink reference signal received power measurement value requirement;
an uplink reference signal received quality measurement value requirement and/or a downlink reference signal received quality measurement value requirement;
a channel impulse response measurement value requirement;
an uplink reference signal time difference measurement value requirement and/or a downlink reference signal time difference measurement value requirement;
a round-trip time measurement value requirement between the base station and a terminal;
an uplink angle-of-arrival measurement value requirement; or
a downlink angle-of-departure measurement value requirement.

In this embodiment of this application, the measurement quantity value requirement includes a measurement value requirement for a downlink signal of one or more base stations, and/or a measurement value requirement on the one or more base stations for an uplink signal of the sensing terminal.

In this embodiment of this application, the measurement quantity value requirement includes a measurement value requirement for a signal of one or more beams.

In this embodiment of this application, the sensing request further includes a candidate sensing terminal quantity indication. In a case that a quantity of terminals that fulfill the first condition is large, the base station may select a better candidate sensing terminal according to the candidate sensing terminal quantity indication in the first condition, to form the candidate sensing terminal list.

In this embodiment of this application, the sensing response further includes at least one of the following:
a measurement quantity value fulfilling the first condition; or
assistance information for assisting in selecting the sensing terminal.

The following describes the sensing terminal selection method of this application by using examples with reference to specific application scenarios.

### Embodiment 1: A Sensing Terminal Selection Method Between a UE and a Core Network Sensing Function Assisted by a Base Station

In this embodiment, the sensing function node (Sensing Function, SF) determines a first condition, the UE determines, according to the first condition based on downlink measurement, whether to participate in sensing, and sends a sensing response to the SF, and the SF determines a sensing terminal according to the sensing response.

This embodiment assumes that the SF is one of core network functions, the first device in the foregoing embodiments is the SF, and the second device and the first device are the same SF.

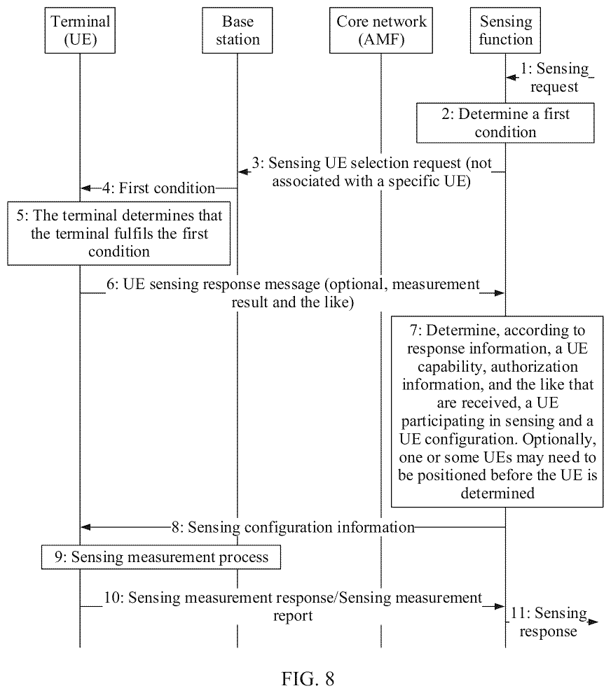

Refer to FIG. 8. The sensing terminal selection method in this embodiment of this application includes the following steps.

Step 1: The sensing function node receives a sensing request, and determines, according to the sensing request, the first condition for selecting the sensing terminal, where the sensing request includes but is not limited to one or more of the following information:
a sensing target area: is a location area in which a sensing object may be present, or a location area that requires imaging or three-dimensional reconstruction;
a sensing object type: a sensing object is classified according to a possible motion characteristic of the sensing object, and each sensing object type includes information such as a motion speed, motion acceleration, and a typical RCS of a typical sensing object;
a sensing target object: in a case that one or more sensing target objects are sensed, identification information of the sensing object is provided, and potential identification manners include characteristic identification on a distance, a speed, and an angle spectrum, or identification based on a UE ID that may be identified by a network; and
sensing QoS: a performance indicator for sensing the sensing target area or the sensing object includes at least one of the following: sensing resolution (which may further include at least one of ranging resolution, angle measurement resolution, speed measurement resolution, or imaging resolution), sensing precision (which may further include at least one of ranging precision, angle measurement precision, speed measurement precision, positioning precision, or the like), a sensing range (which may further include at least one of a ranging range, a speed measurement range, a speed measurement range, an imaging range, or the like), a sensing delay (which is a time interval from sending of a sensing signal to obtaining of a sensing result, or a time interval from initiating of a sensing requirement to obtaining of a sensing result), a sensing update rate (which is a time interval at which two consecutive times of executing sensing and obtaining a sensing result), a detection probability (which is a probability of correctly detecting a sensing object in a case that the sensing object is present), or a false alarm probability (which is a probability of incorrectly detecting a sensing object in a case that the sensing object is absent).

Step 2: The SF determines, according to the sensing request and sensing capability information of a network function that are received (such as a sensing range of the base station, a sensing range of an AMF, information about a sensing service supported by the base station, and/or information about a sensing service supported by the AMF), whether the UE is required to participate in sensing, where that the UE participates in sensing includes one or more of the following: the UE sends a sensing signal, the UE receives a sensing signal and performs sensing measurement, the UE sends sensing assistance information (such as data of a camera or another sensor of the UE), and the UE processes a sensing measurement result. In a case that the UE is required for participation, the first condition for selecting the sensing terminal is determined.

A method for determining the first condition is that the SF determines, according to the sensing target area and the sensing range of the base station, a geographical location requirement for the sensing terminal to participate in sensing.
(a) A base station A (in a case that the sensing target area requires cooperation of multiple base stations, it can be extended to a case of the multiple base stations herein) sends a sensing signal, used for a location area of a UE receiving the sensing signal and measurement.
(b) A base station A (in a case that the sensing target area requires cooperation of multiple base stations, it can be extended to a case of the multiple base stations herein) receives a sensing signal and measurement, used for a location area of a UE sending the sensing signal.
(c) A location area of self-sending and self-receiving of the UE for sensing.
(d) A location area for sending and receiving between UEs.

The SF obtains, based on a radio frequency fingerprint database, a UE measurement quantity and a measurement quantity value requirement that correspond to the geographical location requirement. For example, the measurement quantity value requirement is as follows: A DL RSRP of a cell 1 ranges from −70 dbm to −75 dbm, a DL RSRP of a cell 2 ranges from −100 dbm to −105 dbm, and a DL RSRP of a cell 3 ranges from −89 dbm to −92 dbm. In a case of a multi-antenna system, the foregoing measurement quantity and measurement quantity data may be further represented as measurement on a beam M of a cell.

Taking into account different positioning methods, the first condition for selecting the sensing terminal in this embodiment includes one or more of the following (in this embodiment, the UE autonomously determines whether the first condition is fulfilled, and therefore the first condition is a measurement quantity value requirement for a downlink signal on a UE side):

a downlink Received Signal Strength (RSS) measurement value requirement; where this parameter is a receiving bandwidth power of the UE, including thermal noise within a bandwidth defined by a filter formed in receiver pulses and noise generated by a receiver; and a measurement reference point is an antenna port, and an RSS is an average value of powers of all signals (including a pilot signal, a data signal, an interference signal, a noise signal, and/or the like) received in specific time (such as one symbol);
a SNR; where this parameter is a ratio of a strength of a wanted signal received by the UE to a strength of received noise;
a downlink RSRP measurement value requirement; where this parameter is an average value of reference signal powers in a measurement frequency band, and an RSRP is an average value of powers of signals received in specific time (such as one symbol) on all resources for carrying a reference signal;
a downlink RSRQ measurement value requirement; where this parameter is a ratio of the RSRP and the RSS, and in a case that an RSRP measurement bandwidth and an RSS measurement bandwidth are different, a coefficient is required for adjustment, such as RSRQ=N×RSRP/RSS, where N indicates a quantity of RBs in the RSS measurement bandwidth;
a downlink RSTD measurement value requirement; where this parameter is a time difference of a received signal arriving at multiple TRPs; and
a DL-AOD measurement value requirement; where this parameter is used to measure an angle, and is usually applied in the multi-antenna system to measure an angle-of-arrival or an angle-of-departure of the beam.

It should be noted that in the multi-antenna system, the foregoing signal may be further measured on each beam.

Step 3: The sensing function sends a second sensing request (that is, a sensing UE selection request in the figure) to one or more determined base stations. It should be noted that, the second sensing request message is a non-UE associated message, namely, a global message. In a case that a protocol stack between the sensing function and the base station is forwarded by an AMF, a same manner is used for the message, but an NGAP message (that is, a protocol stack message between a core network and the base station) that carries the message is a non-UE associated message, that is, does not carry a UE NGAP ID (that is, a RAN UE NGAP ID) allocated by the base station. In a case that a protocol stack between the sensing function and the base station does not require forwarding of an AMF, the message may be sent directly by the sensing function to the corresponding base station.

Step 4: The base station broadcasts and sends the first condition in a corresponding cell according to the received first condition, where the first condition may further include an SF identifier, used to trigger a terminal that fulfills the first condition and is willing to participate in sensing to send a sensing response message. The SF identifier indicates an SF that receives the sensing response message of the UE.

That the first condition is broadcast and sent may be that the first condition is sent through a paging message or the first condition is sent through system information of a cell. Terminals in an idle state and an inactive state monitor changes of the paging message and the system information, and receive the paging message or the system information to obtain the first condition.

The first condition may be sent only to the UEs in the idle state and the inactive state, or sent to UEs in all states. For the latter, there are two sending methods for a UE in a connected state:

Method 1: The first condition may be carried in a dedicated RRC message sent to the UE.

Method 2: A dedicated RNTI is used for the paging message, and the UE in the connected state also monitors the dedicated RNTI, and receives the paging message to obtain the first condition.

In some embodiments, in addition to sending the first condition, the base station may further send sensing information to the terminal. For example, the sensing information includes cost information (for example, how much traffic or call charges may be obtained by participating in a sensing task), estimated sensing duration, and the like. The terminal may evaluate, based on these information, whether the terminal is willing to join the sensing task.

Step 5: The terminal may determine, according to currently completed downlink signal measurement, whether the terminal fulfills the first condition; or the terminal measures the downlink signal according to the received first condition, and determines, according to a measurement result, whether the first condition is fulfilled. In a case that the first condition is fulfilled, the terminal determines whether to respond to the SF to send the sensing response message. Possible methods include:

Method 1: The terminal that fulfills the first condition always responds to the SF to send the sensing response message.

Method 2: The terminal that fulfills the first condition may have a degree of autonomy, and may determine, according to a status of the terminal, whether to send the sensing response message, such as sensing cost information and a power status. For example, in a case that power of the terminal is low or sensing costs are lower than a threshold, the terminal may still determine not to send the sensing response message even if the first condition is fulfilled.

Step 6: The terminal sends the sensing response message to the SF indicated in the first condition (in this embodiment, the same SF as the SF that sends the first condition) to indicate that the terminal is willing to participate in the sensing service. The sensing response message may be an RRC message, such as a UE assistance information message, similar to MDT, indicating an IP address of a target receiver of the message. The sensing response message should include an identifier of the UE, and the identifier is an identifier that may be identified by the SF, such as a core network identifier SUPI of the UE or a Globally Unique Temporary Identifier (GUTI) of the UE.

It should be noted that when the UE is the idle state or the inactive state, the terminal first initiates an RRC connection establishment or RRC connection resume process to enter the connected state. An establishment reason or a resume reason may indicate to respond to the sensing request.

In some embodiments, the sensing response messages may include the following information to assist the SF in further terminal selection:
a measurement result that fulfills the first condition, for example, measured received signal strength values of multiple TRPs; and
an orientation of the UE, a speed of the UE, duration for the UE to maintain a current motion state (that is, time for maintaining the motion state unchanged such as a current location, a current orientation, and a current speed), and the like, where in a case that a future location of the UE is known or predictable, the UE may provide location information for a time period in the future; and when the UE supports receiving and receiving sensing between UEs, in a case that the UE recommends a UE that may cooperate with the UE for sensing, the UE may provide an identifier of the UE recommended.

Step 7: The SF may receive sensing response messages from multiple terminals. The SF may query a sensing capability and authorization information of the UE according to identification information of the UE to obtain specific sensing services supported and authorized by the UE, and therefore determine the sensing terminal. In some embodiments, the SF may obtain the location information of the UE according to a measurement result in the sensing response message, to assist in determining the UE; or initiate a positioning procedure to the UE based on the UE ID to obtain the location information of the UE; or determine the sensing terminal based on other assistance information provided by the UE.

In a case that the SF determines the geographical location requirement for the sensing terminal to participate in the sensing, geographical location requirements in multiple sensing manners are related. Therefore, sensing responses received by the SF also relate to sensing responses of terminals determined according to the multiple geographical location requirements. In this step, the SF further needs to determine a sensing manner and select a sensing terminal corresponding to the sensing manner.

Step 8: The SF sends the determined sensing manner (sending of the base station and receiving of the UE, receiving of the base station and sending of the UE, sending between UEs, and self-sending and self-receiving of the UE) and sensing configuration information to the UE and the base station.

Step 9: Assuming that the sensing manner is sending of the base station and receiving of the UE, the base station sends a sensing signal, and the terminal receives the sensing signal and performs measurement.

Step 10: The UE sends a sensing measurement result to the SF.

Step 11: The SF obtains the sensing result based on the sensing measurement result and determines whether to trigger sending of the sensing response to a third party or a core network function (such as the AMF). For example, when the sensing result does not meet a requirement, the SF may continue to receive more sensing measurement results; or when the sending result meets a requirement, the SF triggers sending of the sensing response to the third party or the core network function (such as the AMF). The sensing response should carry the sensing result.

### Embodiment 2: A Sensing Terminal Selection Method in which a Core Network Sensing Function Cooperates with a Base Station

In this embodiment, the SF determines a first condition, the base station determines a candidate sensing terminal list based on the first condition and an uplink measurement result and/or a downlink measurement result, and the SF determines a sensing terminals according to the candidate sensing terminal list. This embodiment is more applicable to a UE in a connected state.

This embodiment assumes that the SF is one of core network functions, a first device is the SF, and a second device and the first device are the same SF.

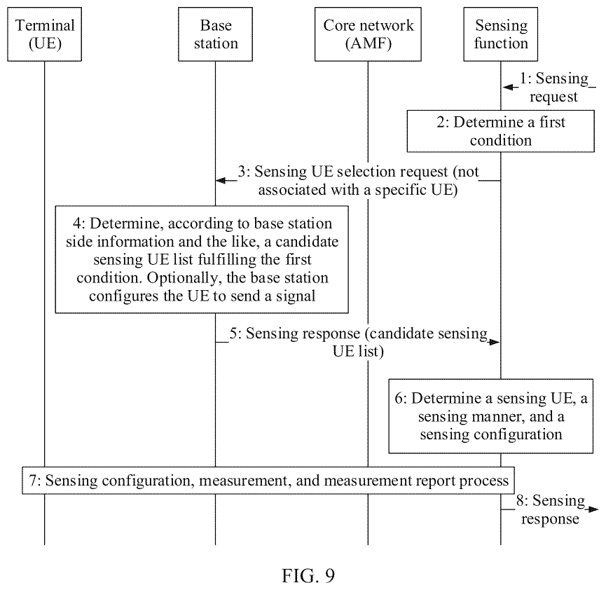

Refer to FIG. 9. The sensing terminal selection method in this embodiment of this application includes the following steps.

Step 1: The sensing function node receives a sensing request, and determines, according to the sensing request, the first condition for selecting the sensing terminal, where the sensing request includes but is not limited to one or more of the following information:
a sensing target area: is a location area in which a sensing object may be present, or a location area that requires imaging or three-dimensional reconstruction;
a sensing object type: a sensing object is classified according to a possible motion characteristic of the sensing object, and each sensing object type includes information such as a motion speed, motion acceleration, and a typical RCS of a typical sensing object;
a sensing target object: in a case that one or more sensing target objects are sensed, identification information of the sensing object is provided, and potential identification manners include characteristic identification on a distance, a speed, and an angle spectrum, or identification based on a UE ID that may be identified by a network; and
sensing QoS: a performance indicator for sensing the sensing target area or the sensing object includes at least one of the following: sensing resolution (which may further include at least one of ranging resolution, angle measurement resolution, speed measurement resolution, or imaging resolution), sensing precision (which may further include at least one of ranging precision, angle measurement precision, speed measurement precision, positioning precision, or the like), a sensing range (which may further include at least one of a ranging range, a speed measurement range, a speed measurement range, an imaging range, or the like), a sensing delay (which is a time interval from sending of a sensing signal to obtaining of a sensing result, or a time interval from initiating of a sensing requirement to obtaining of a sensing result), a sensing update rate (which is a time interval at which two consecutive times of executing sensing and obtaining a sensing result), a detection probability (which is a probability of correctly detecting a sensing object in a case that the sensing object is present), or a false alarm probability (which is a probability of incorrectly detecting a sensing object in a case that the sensing object is absent).

Step 2: The SF determines, according to the sensing request and sensing capability information of a network function that are received (such as a sensing range of the base station, a sensing range of an AMF, information about a sensing service supported by the base station, and/or information about a sensing service supported by the AMF), whether the UE is required to participate in sensing, where that the UE participates in sensing includes one or more of the following: the UE sends a sensing signal, the UE receives a sensing signal and performs sensing measurement, the UE sends sensing assistance information (such as data of a camera or another sensor of the UE), and the UE processes a sensing measurement result. In a case that the UE is required for participation, the first condition for selecting the sensing terminal is determined.

A method for determining the first condition is that the SF determines, according to the sensing target area and the sensing range of the base station, a geographical location requirement for the sensing terminal to participate in sensing.
(a) A base station A (in a case that the sensing target area requires cooperation of multiple base stations, it can be extended to a case of the multiple base stations herein) sends a sensing signal, used for a location area of a UE receiving the sensing signal and measurement.
(b) A base station A (in a case that the sensing target area requires cooperation of multiple base stations, it can be extended to a case of the multiple base stations herein) receives a sensing signal and measurement, used for a location area of a UE sending the sensing signal.
(c) A location area of self-sending and self-receiving of the UE for sensing.
(d) A location area for sending and receiving between UEs.

The SF obtains, based on a radio frequency fingerprint database, a UE measurement quantity and a measurement quantity value requirement that correspond to the geographical location requirement. For example, the measurement quantity value requirement is as follows: A DL RSRP of a cell 1 ranges from −70 dbm to −75 dbm, a DL RSRP of a cell 2 ranges from −100 dbm to −105 dbm, and a DL RSRP of a cell 3 ranges from −89 dbm to −92 dbm. In a case of a multi-antenna system, the foregoing measurement quantity and measurement quantity data may be further represented as measurement on a beam M from the UE.

Taking into account different positioning methods, the first condition for selecting the sensing terminal in this embodiment includes one or more of the following (in this embodiment, the base station determines whether the UE fulfills the first condition, and because the base station may measure an uplink signal of the UE, the first condition may be based totally on an uplink measurement result. At the same time, the UE may also report a downlink measurement result to the base station. Therefore, the first condition may be a value requirement for the uplink measurement result and/or a value requirement for the downlink measurement result):
a CIR measurement value requirement; where this parameter is a complex-number result of a channel response, and considering air interface transmission overheads, the channel impulse response usually means a measurement value of a UE uplink channel impulse response on a base station side;
an uplink received signal strength measurement value requirement and/or a downlink Received Signal Strength (RSS) measurement value requirement; where this parameter is a receiving bandwidth power of the base station and/or the UE, including thermal noise within a bandwidth defined by a filter formed in receiver pulses and noise generated by a receiver; and a measurement reference point is an antenna port, and an RSS is an average value of powers of all signals (including a pilot signal, a data signal, an interference signal, a noise signal, and/or the like) received in specific time (such as one symbol);
a SNR; where this parameter is a ratio of a strength of a wanted signal received by the base station and/or the UE to a strength of received noise;
an uplink RSRP measurement value requirement and/or a downlink RSRP measurement value requirement; where this parameter is an average value of reference signal powers in a measurement frequency band, and an RSRP is an average value of powers of signals received in specific time (such as one symbol) on all resources for carrying a reference signal;
an uplink RSRQ measurement value requirement and/or a downlink RSRQ measurement value requirement; where this parameter is a ratio of the RSRP and the RSS, and in a case that an RSRP measurement bandwidth and an RSS measurement bandwidth are different, a coefficient is required for adjustment, such as RSRQ=N×RSRP/RSS, where N indicates a quantity of RBs in the RSS measurement bandwidth;
an uplink RSTD measurement value requirement and/or a downlink RSTD measurement value requirement; where this parameter is a time difference of a received signal arriving at multiple TRPs;
an UL-AoA measurement value requirement and/or a DL-AoD measurement value requirement; where this parameter is used to measure an angle, and is usually applied in the multi-antenna system to measure an angle-of-arrival or an angle-of-departure of the beam;
an RTT measurement value requirement between the UE and the base station; where assuming that time for a node 1 to send a signal is to, time for a node 2 to receive the signal is t1, time for the node 2 to send a signal is t2, and time for the node 1 to receive the signal is t3, RTT=t1−t0+t3−t2=(t3−t0)+ (t1−t2); and
a candidate sensing terminal quantity indication, indicating a maximum quantity of candidate sensing terminals required to avoid excessive measurement and data interaction.

It should be noted that in the multi-antenna system, the foregoing signal may be further measured on each beam.

Step 3: The sensing function sends a second sensing request (that is, a sensing UE selection request in the figure) to one or more determined base stations. It should be noted that, the second sensing request message is a non-UE associated message, namely, a global message. In a case that a protocol stack between the sensing function and the base station is forwarded by an AMF, a same manner is used for the message, but an NGAP message (that is, a protocol stack message between a core network and the base station) that carries the message is a non-UE associated message, that is, does not carry a UE NGAP ID (that is, a RAN UE NGAP ID) allocated by the base station. In a case that a protocol stack between the sensing function and the base station does not require forwarding of an AMF, the message may be sent directly by the sensing function to the corresponding base station.

Step 4: The base station determines, based on the received first condition, the uplink signal measurement result on the base station side, and/or the downlink measurement result reported by the UE, specific UEs fulfilling the first condition. In some embodiments, in a case that a quantity of UEs that fulfill the condition is large, the base station selects a better candidate sensing terminal according to the candidate sensing terminal quantity indication in the first condition, to form the candidate sensing terminal list.

Step 5: The base station sends a sensing response message to the SF, where the sensing response message includes the candidate sensing terminal list. For example, the candidate sensing terminal list is formed by a UE network identifier (RAN-UE-NGAP ID and the like). In some embodiments, the sensing response message may further include the following information to assist the SF in further terminal selection: a measurement result that fulfills the first condition, for example, measured received signal strength values of multiple TRPs.

It should be noted that this embodiment is more suitable for the UE in the connected state, the uplink signal of the UE may be measured on the base station side, and in some embodiments, the base station can instruct the UE to measure and report the downlink signal.

Step 6: The SF queries a sensing capability and authorization information of the UE according to the received candidate sensing terminal list and identification information of the UE to obtain specific sensing services supported and authorized by the UE, and therefore determine the sensing terminal. In some embodiments, the SF may obtain the location information of the UE according to a measurement result in the sensing response message, to assist in determining the UE; or initiate a positioning procedure to the UE based on the UE ID to obtain the location information of the UE.

In a case that the SF determines the geographical location requirement for the sensing terminal to participate in the sensing, geographical location requirements in multiple sensing manners are related. Therefore, sensing responses received by the SF also relate to sensing responses of terminals determined according to the multiple geographical location requirements. In this step, the SF further needs to determine a sensing manner and select a sensing terminal corresponding to the sensing manner.

Step 7: The SF sends the determined sensing manner (sending of the base station and receiving of the UE, receiving of the base station and sending of the UE, sending between UEs, and self-sending and self-receiving of the UE) and sensing configuration information to the UE and the base station. Assuming that the sensing manner is sending of the base station and receiving of the UE, the base station sends a sensing signal, and the terminal receives the sensing signal and performs measurement. The UE sends a sensing measurement result to the SF.

Step 8: The SF obtains the sensing result based on the sensing measurement result and determines whether to trigger sending of the sensing response to a third party or a core network function (such as the AMF). For example, when the sensing result does not meet a requirement, the SF may continue to receive more sensing measurement results; or when the sending result meets a requirement, the SF triggers sending of the sensing response to the third party or the core network function (such as the AMF). The sensing response should carry the sensing result.

### Embodiment 3: A Sensing Terminal Selection Method Between a Base Station and a UE

In this embodiment, the base station determines a first condition and broadcasts the first condition to the UE, the UE determines, based on the first condition and downlink measurement, whether to participate in sensing, and sends a sensing response to the base station, and the base station determines a sensing terminal according to the sensing response.

In this embodiment, a first device is the base station, the base station determines, according to a sensing request and the like sent by a core network function (such as an SF), the first condition for selecting the sensing terminal, and sends the first condition to the UE. The UE determines, based on downlink measurement, whether the condition is fulfilled, and sends a sensing response to the base station in a case that the condition is fulfilled and the UE is willing to participate. Considering that only the core network function can usually query subscription and authorization information of the UE, for the base station side, in a case that the UE sends the sensing response to the base station, it indicates that the UE agrees to participate in sensing. In some embodiments, the base station determines the sensing terminal and sensing configuration information with reference to uplink measurement and other information.

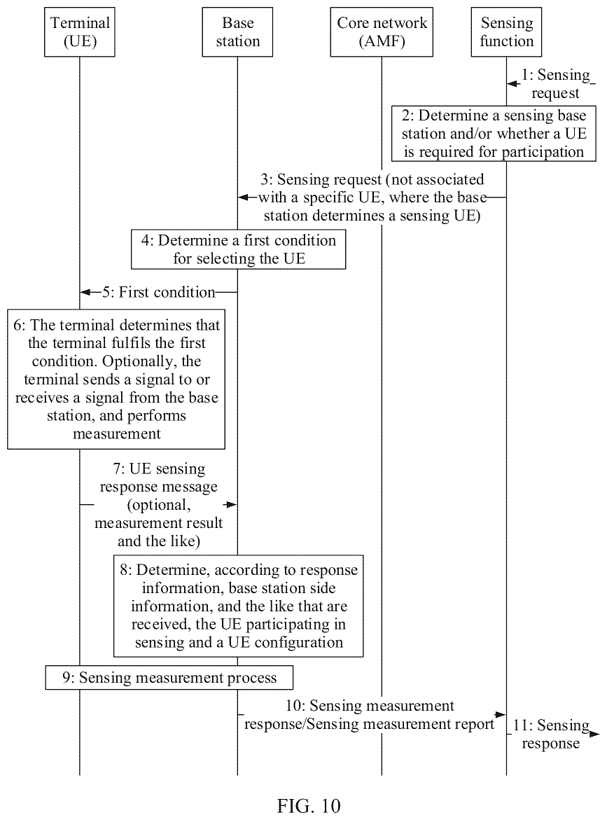

Refer to FIG. 10. The sensing terminal selection method in this embodiment of this application includes the following steps.

Step 1: The sensing function node receives a sensing request, and determines, according to the sensing request, the first condition for selecting the sensing terminal, where the sensing request includes but is not limited to one or more of the following information:
a sensing target area: is a location area in which a sensing object may be present, or a location area that requires imaging or three-dimensional reconstruction;
a sensing object type: a sensing object is classified according to a possible motion characteristic of the sensing object, and each sensing object type includes information such as a motion speed, motion acceleration, and a typical RCS of a typical sensing object;
a sensing target object: in a case that one or more sensing target objects are sensed, identification information of the sensing object is provided, and potential identification manners include characteristic identification on a distance, a speed, and an angle spectrum, or identification based on a UE ID that may be identified by a network; and
sensing QoS: a performance indicator for sensing the sensing target area or the sensing object includes at least one of the following: sensing resolution (which may further include at least one of ranging resolution, angle measurement resolution, speed measurement resolution, or imaging resolution), sensing precision (which may further include at least one of ranging precision, angle measurement precision, speed measurement precision, positioning precision, or the like), a sensing range (which may further include at least one of a ranging range, a speed measurement range, a speed measurement range, an imaging range, or the like), a sensing delay (which is a time interval from sending of a sensing signal to obtaining of a sensing result, or a time interval from initiating of a sensing requirement to obtaining of a sensing result), a sensing update rate (which is a time interval at which two consecutive times of executing sensing and obtaining a sensing result), a detection probability (which is a probability of correctly detecting a sensing object in a case that the sensing object is present), or a false alarm probability (which is a probability of incorrectly detecting a sensing object in a case that the sensing object is absent).

Step 2: The SF determines a sensing base station according to the sensing request and sensing capability information of a network function that are received (such as a sensing range of the base station, a sensing range of an AMF, information about a sensing service supported by the base station, and/or information about a sensing service supported by the AMF). In some embodiments, the SF further determines whether the UE is required to participate in sensing, and the base station may determine whether the UE is required to participate in sensing.

Step 3: The SF sends the sensing request to one or more determined base stations. It should be noted that, the sensing request message is a non-UE associated message, to indicate that the base station has completed sensing, and specific sensing terminals selected are determined by the base station.

Step 4: The base station determines, according to the received sensing request (such as the sensing target area and the sensing QoS), whether the UE is required to participate in sensing, where that the UE participates in sensing includes one or more of the following: the UE sends a sensing signal, the UE receives a sensing signal and performs sensing measurement, the UE sends sensing assistance information (such as data of a camera or another sensor of the UE), and the UE processes a sensing measurement result. In a case that the UE is required for participation, the first condition for selecting the sensing terminal is determined.

A method for determining the first condition is that the base station determines, according to the sensing target area, a geographical location requirement for the sensing terminal to participate in sensing.
(a) A base station A (in a case that the sensing target area requires cooperation of multiple base stations, it can be extended to a case of the multiple base stations herein) sends a sensing signal, used for a location area of a UE receiving the sensing signal and measurement.
(b) A base station A (in a case that the sensing target area requires cooperation of multiple base stations, it can be extended to a case of the multiple base stations herein) receives a sensing signal and measurement, used for a location area of a UE sending the sensing signal.

The base station obtains, based on a radio frequency fingerprint database, a UE measurement quantity and a measurement quantity value requirement that correspond to the geographical location requirement. For example, the measurement quantity value requirement is as follows: A DL RSRP of a cell 1 ranges from −70 dbm to −75 dbm, a DL RSRP of a cell 2 ranges from −100 dbm to −105 dbm, and a DL RSRP of a cell 3 ranges from −89 dbm to −92 dbm. In a case of a multi-antenna system, the foregoing measurement quantity and measurement quantity data may be further represented as measurement on a beam M of a cell.

Taking into account different positioning methods, the first condition for selecting the sensing terminal in this embodiment includes one or more of the following:
a CIR measurement value requirement; where this parameter is a complex-number result of a channel response, and considering air interface transmission overheads, the channel impulse response usually means a measurement value of a UE uplink channel impulse response on a base station side;
an uplink received signal strength measurement value requirement and/or a downlink Received Signal Strength (RSS) measurement value requirement; where this parameter is a receiving bandwidth power of the UE, including thermal noise within a bandwidth defined by a filter formed in receiver pulses and noise generated by a receiver; and a measurement reference point is an antenna port, and an RSS is an average value of powers of all signals (including a pilot signal, a data signal, an interference signal, a noise signal, and/or the like) received in specific time (such as one symbol);
a CIR measurement value requirement; where this parameter is a complex-number result of a channel response, and considering air interface transmission overheads, the channel impulse response usually means a measurement value of a UE uplink channel impulse response on a base station side;
an uplink RSS measurement value requirement and/or a downlink RSS measurement value requirement; where this parameter is a receiving bandwidth power of the base station and/or the UE, including thermal noise within a bandwidth defined by a filter formed in receiver pulses and noise generated by a receiver; and a measurement reference point is an antenna port, and an RSS is an average value of powers of all signals (including a pilot signal, a data signal, an interference signal, a noise signal, and/or the like) received in specific time (such as one symbol);
a SNR; where this parameter is a ratio of a strength of a wanted signal received by the base station and/or the UE to a strength of received noise;
an uplink RSRP measurement value requirement and/or a downlink RSRP measurement value requirement; where this parameter is an average value of reference signal powers in a measurement frequency band, and an RSRP is an average value of powers of signals received in specific time (such as one symbol) on all resources for carrying a reference signal;
an uplink reference signal received quality measurement value requirement and/or a downlink reference signal received quality (RSRQ) measurement value requirement; where this parameter is a ratio of the RSRP and the RSS, and in a case that an RSRP measurement bandwidth and an RSS measurement bandwidth are different, a coefficient is required for adjustment, such as RSRQ=N×RSRP/RSS, where N indicates a quantity of RBs in the RSS measurement bandwidth;
an uplink RSTD measurement value requirement and/or a downlink RSTD measurement value requirement; where this parameter is a time difference of a received signal arriving at multiple TRPs;
a DL-AoA measurement value requirement and/or a DL-AoD measurement value requirement; where this parameter is used to measure an angle, and is usually applied in the multi-antenna system to measure an angle-of-arrival or an angle-of-departure of the beam;
an RTT measurement value requirement between the UE and the base station; where assuming that time for a node 1 to send a signal is to, time for a node 2 to receive the signal is t1, time for the node 2 to send a signal is t2, and time for the node 1 to receive the signal is t3, RTT=t1−t0+t3−t2−(t3−t0)+ (t1−t2); and
a candidate sensing terminal quantity indication, indicating a maximum quantity of candidate sensing terminals required to avoid excessive measurement and data interaction.

It should be noted that in the multi-antenna system, the foregoing signal may be further measured on each beam.

In a case that the base station determines a candidate UE based on known information on the base station side (such as the uplink measurement result) according to the determined first condition, considering that only the core network function can usually query subscription and authorization information of the UE, for the base station side, the base station should further send a sensing request message to the UE. The sensing request message includes sensing content, sensing duration, sensing costs, and other information. The UE determines, based on the information, whether the UE is willing to participate. In a case that the UE sends the sensing response to the base station, it indicates that the UE agrees to participate in sensing.

Step 5: In a case that the information on the base station side cannot be used to determine a UE that fulfills the first condition, the base station broadcasts the first condition in a corresponding cell, used to trigger a terminal that fulfills the first condition and is willing to participate in sensing to send a sensing response message. Further, the base station may broadcast and send the first condition on a specified beam of the corresponding cell according to the determined area, to avoid a case in which all UEs within the coverage area of the cell receive the broadcast information, and reduce cell broadcast overheads and UE detection overheads.

That the first condition is broadcast and sent may be that the first condition is sent through a paging message or the first condition is sent through system information of a cell. Terminals in an idle state and an inactive state monitor changes of the paging message and the system information, and receive the paging message or the system information to obtain the first condition.

The first condition may be sent only to the UEs in the idle state and the inactive state, or sent to UEs in all states. For the latter, there are two sending methods for a UE in a connected state:
Method 1: The first condition may be carried in a dedicated RRC message sent to the UE.
Method 2: A dedicated RNTI is used for the paging message, and the UE in the connected state also monitors the dedicated RNTI, and receives the paging message to obtain the first condition.

In some embodiments, in addition to sending the first condition, the base station may further send sensing information to the terminal. For example, the sensing information includes cost information (for example, how much traffic or call charges may be obtained by participating in a sensing task), estimated sensing duration, and the like. The terminal may evaluate, based on these information, whether the terminal is willing to join the sensing task.

Step 6: The terminal may determine, according to currently completed downlink signal measurement, whether the terminal fulfills the first condition; or the terminal measures the downlink signal according to the received first condition, and determines, according to a measurement result, whether the first condition is fulfilled. In a case that the first condition is fulfilled, the terminal determines whether to respond to the base station to send the sensing response message. Possible methods include:
Method 1: The terminal that fulfills the first condition always responds to the base station to send the sensing response message.
Method 2: The terminal that fulfills the first condition may have a degree of autonomy, and may determine, according to a status of the terminal, whether to send the sensing response message, such as sensing cost information and a power status. For example, in a case that power of the terminal is low or sensing costs are lower than a threshold, the terminal may still determine not to send the sensing response message even if the first condition is fulfilled.

Step 7: The terminal sends the sensing response message to the base station.

Step 8: The base station determines the sensing terminal and sensing configuration information according to the received sensing response message and the information on the base station side.

Step 9: The base station sends a sensing signal, and the terminal receives the sensing signal and performs measurement. In some embodiments, the terminal sends a sensing signal, and the base station receives the sensing signal and performs measurement.

Step 10: The base station and/or the UE send/sends a sensing measurement result to the SF.

Step 11: The SF obtains the sensing result based on the sensing measurement result and determines whether to trigger sending of the sensing response to a third party or a core network function (such as the AMF). For example, when the sensing result does not meet a requirement, the SF may continue to receive more sensing measurement results; or when the sending result meets a requirement, the SF triggers sending of the sensing response to the third party or the core network function (such as the AMF). The sensing response should carry the sensing result.

### Embodiment 4: A Sensing Terminal Selection Method in which a Core Network Function, a Base Station, and a UE Cooperate

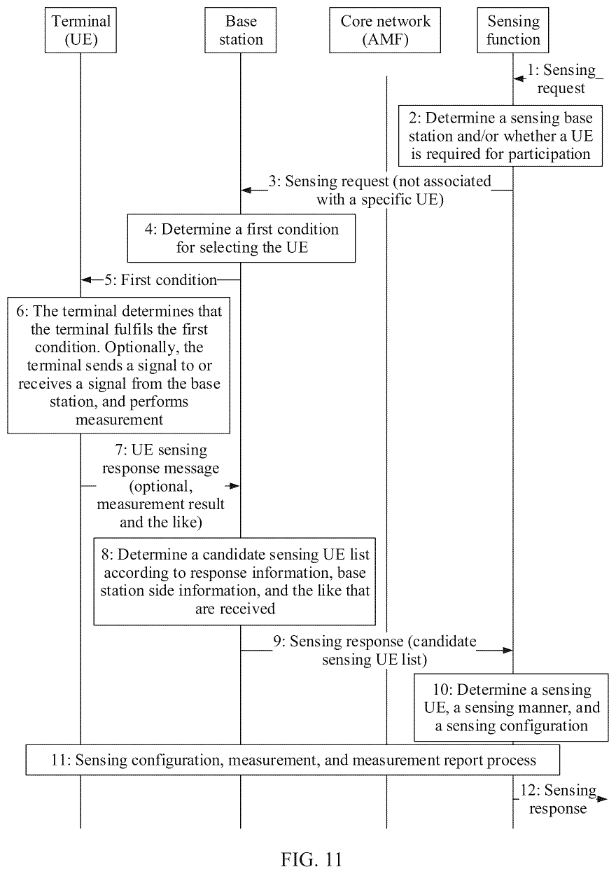

Refer to FIG. 11. In this embodiment, the base station determines a first condition, and determines a candidate sensing terminal list based on a downlink measurement result and/or an uplink measurement result, and an SF determines a sensing terminals according to the candidate sensing terminal list.

In this embodiment, a first device is the base station, the base station determines, according to a sensing request sent by the core network function (such as the SF), the first condition for selecting the sensing terminal. According to the determined first condition, in a case that the base station may determine the candidate sensing terminal list according to the information on the base station side, the candidate sensing terminal list is sent to the SF. In a case that the base station cannot determine the candidate sensing terminal list, the first condition is sent to the UE, and the base station side determines the candidate sensing terminal list according to received sensing response information of the UE and/or the information on the base station side. For other steps, refer to Embodiments 1 and 2. Details are not described again herein.

The foregoing methods in the embodiments are applicable to a 5.5G or 6G communication system or another communication system in the future.

The sensing terminal selection method provided in the embodiments of this application may be performed by a sensing terminal selection apparatus. In the embodiments of this application, the sensing terminal selection apparatus provided in the embodiments of this application is described by using an example in which the sensing terminal selection apparatus performs the sensing terminal selection method.

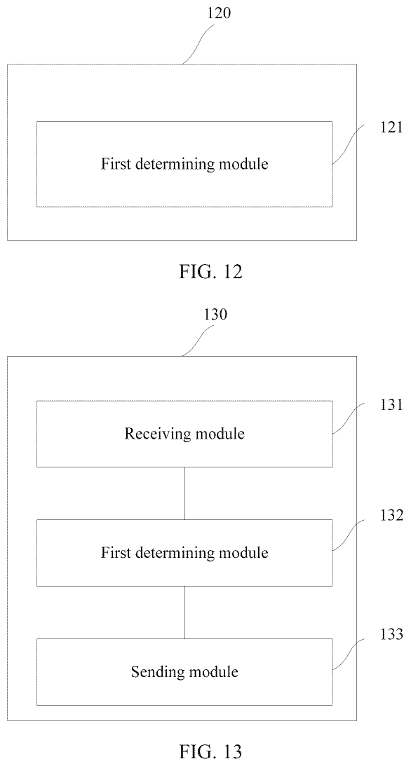

Refer to FIG. 12. An embodiment of this application further provides a sensing terminal selection apparatus 120. The sensing terminal selection apparatus 120 includes:
a first determining module 121, configured to determine a first condition for selecting a sensing terminal, where the first condition includes a geographical location requirement for the sensing terminal to participate in sensing, and/or a measurement quantity value requirement corresponding to the geographical location requirement.

In this embodiment of this application, the sensing terminal selection apparatus determines the first condition for selecting the sensing terminal, where the first condition is related to the geographical location requirement for the sensing terminal to participate in the sensing, and/or the measurement quantity value requirement corresponding to the geographical location requirement. In this way, a terminal fulfilling the condition may be determined according to the first condition, to resolve a problem that a network side cannot know the terminal suitable for sensing in a sensing area.

In some embodiments, the first determining module 121 is configured to determine whether a terminal is required to participate in sensing; and in a case that the first determining module 121 determines that the terminal is required to participate in the sensing, determine the first condition for selecting the sensing terminal.

In some embodiments, the first determining module 121 is configured to determine, based on at least one of a first sensing request and sensing capability information of a network function that are received, whether the terminal is required to participate in the sensing, where
the first sensing request includes at least one of the following: a sensing target area, a sensing object type, a sensing target object, or sensing QoS; and
the sensing capability information of the network function includes at least one of the following: a sensing range of a base station, a sensing range of an AMF, information about a sensing service supported by the base station, or information about a sensing service supported by the AMF.

In some embodiments, that the terminal is required to participate in the sensing includes at least one of the following: the terminal is required to send a sensing signal, the terminal is required to receive a sensing signal and perform sensing measurement, the terminal is required to send sensing assistance information, or the terminal is required to process a sensing measurement result.

In some embodiments, the measurement quantity value requirement includes at least one of the following:
an uplink received signal strength measurement value requirement and/or a downlink received signal strength measurement value requirement;
a signal-to-noise ratio requirement;
an uplink reference signal received power measurement value requirement and/or a downlink reference signal received power measurement value requirement;
an uplink reference signal received quality measurement value requirement and/or a downlink reference signal received quality measurement value requirement;
a channel impulse response measurement value requirement;
an uplink reference signal time difference measurement value requirement and/or a downlink reference signal time difference measurement value requirement;
a round-trip time measurement value requirement between a base station and a terminal;
an uplink angle-of-arrival measurement value requirement; or
a downlink angle-of-departure measurement value requirement.

In some embodiments, the measurement quantity value requirement includes a measurement value requirement on the terminal for a downlink signal of one or more base stations, and/or a measurement value requirement on the one or more base stations for an uplink signal of the terminal.

In some embodiments, the measurement quantity value requirement includes a measurement value requirement for a signal of one or more beams.

In some embodiments, the first determining module 121 is configured to determine the geographical location requirement for the sensing terminal to participate in the sensing; and determine the measurement quantity value requirement corresponding to the geographical location requirement.

In some embodiments, the geographical location requirement includes at least one of the following:
a geographical location at which a terminal is required to participate in sensing in a case that a sensing manner is that a base station sends a sensing signal and the terminal receives the sensing signal and performs sensing measurement;
a geographical location at which a terminal is required to participate in sensing in a case that a sensing manner is that the terminal sends a sensing signal and a base station receives the sensing signal and performs sensing measurement;
a geographical location at which a terminal is required to participate in sensing in a case that a sensing manner is that the terminal sends a sensing signal and the terminal receives the sensing signal and performs sensing measurement; or
a geographical location at which a terminal is required to participate in sensing in a case that a sensing manner is that the terminal sends a sensing signal and another terminal receives the sensing signal and performs sensing measurement.

In some embodiments, the sensing terminal selection apparatus 120 is a sensing function node. The sensing terminal selection apparatus 120 further includes:
a first sending module, configured to send a second sensing request to a base station, where the second sensing request includes the first condition and an identifier of a second device for receiving a sensing response, and the second sensing request is broadcast by the base station.

In some embodiments, the sensing terminal selection apparatus 120 further includes:
a first receiving module, configured to receive a sensing response sent by a terminal for the second sensing request, where the sensing response includes at least one of the following: an identifier of the terminal, indication information indicating that the terminal is willing to participate in sensing, a measurement quantity value fulfilling the first condition, or assistance information for assisting in selecting the sensing terminal; and
a second determining module, configured to determine the sensing terminal according to the sensing response.

In some embodiments, the assistance information includes at least one of the following: an orientation of the terminal, a speed of the terminal, duration for the terminal to maintain a current motion state, location information of the terminal in future preset time, or another terminal identifier recommended by the terminal, where the another terminal identifier recommended is an identifier of another terminal that cooperates with the terminal for sensing in a case that a sensing manner is that a sensing signal is sent and received between terminals.

In some embodiments, the sensing terminal selection apparatus 120 is a sensing function node. The sensing terminal selection apparatus 120 further includes:
a second sending module, configured to send a second sensing request to a base station, where the second sensing request includes the first condition.

In some embodiments, the second sensing request further includes a candidate sensing terminal quantity indication and/or an identifier of a second device for receiving a sensing response.

In some embodiments, the sensing terminal selection apparatus 120 further includes:
a second receiving module, configured to receive a sensing response sent by the base station for the second sensing request, where the sensing response includes at least one of the following: a candidate sensing terminal list, a measurement quantity value fulfilling the first condition, or assistance information for assisting in selecting the sensing terminal; and
a third determining module, configured to determine the sensing terminal according to the sensing response.

In some embodiments, the assistance information includes communication load information of a candidate terminal.

In some embodiments, the sensing terminal selection apparatus 120 is a base station. The sensing terminal selection apparatus 120 further includes:
a fourth determining module, configured to determine a candidate sensing terminal list according to the first condition.

In some embodiments, the sensing terminal selection apparatus 120 further includes:
a third sending module, configured to send a third sensing request to a terminal in the candidate sensing terminal list, where the third sensing request is used to request the terminal to participate in sensing;
a third receiving module, configured to receive a sensing response of the terminal for the third sensing request, where the sensing response indicates whether the terminal agrees to participate in the sensing; and
a fifth determining module, configured to determine a target sensing terminal list according to the sensing response.

In some embodiments, the third sensing request includes sensing information, and the sensing information includes at least one of the following: cost information for participating in sensing and estimated sensing duration.

In some embodiments, the fourth determining module is configured to: in a case that the first condition includes a measurement quantity value requirement for an uplink signal, determine the candidate sensing terminal list according to the first condition.

In some embodiments, the fourth determining module is configured to: in a case that the first condition includes a measurement quantity value requirement for a downlink signal, send a fourth sensing request to a terminal, where the fourth sensing request includes the first condition; receive a sensing response of the terminal for the fourth sensing request, where the sensing response includes at least one of the following: an identifier of the terminal, indication information indicating that the terminal is willing to participate in sensing, a measurement quantity value fulfilling the first condition, and assistance information for assisting in selecting the sensing terminal; and determine the candidate sensing terminal list according to the sensing response.

In some embodiments, the fourth determining module is configured to: in a case that the first condition includes a measurement quantity value requirement for an uplink signal and a measurement quantity value requirement for a downlink signal, determine a candidate sensing terminal according to the measurement quantity value requirement for the uplink signal in the first condition; send a fourth sensing request to a terminal, where the fourth sensing request includes the first condition; receive a sensing response of the terminal for the fourth sensing request, where the sensing response includes at least one of the following: an identifier of the terminal, indication information indicating that the terminal is willing to participate in sensing, a measurement quantity value fulfilling the first condition, and assistance information for assisting in selecting the sensing terminal; and determine the candidate sensing terminal list according to the sensing response and the candidate sensing terminal determined by the fourth determining module.

In some embodiments, the sensing terminal selection apparatus 120 further includes:
a sixth determining module, configured to determine the sensing terminal according to the candidate sensing terminal list.

In some embodiments, the sensing terminal selection apparatus 120 further includes:
a fourth sending module, configured to send the candidate sensing terminal list to a sensing function node.

The sensing terminal selection apparatus in this embodiment of this application may be an electronic device, for example, an electronic device with an operating system, or may be a component in the electronic device, for example, an integrated circuit or a chip.

The sensing terminal selection apparatus provided in this embodiment of this application can implement the processes implemented in the method embodiment in FIG. 2, and achieve a same technical effect. To avoid repetition, details are not described herein again.

Refer to FIG. 13. An embodiment of this application further provides a sensing terminal selection apparatus 130. The sensing terminal selection apparatus 130 includes:
a receiving module 131, configured to receive a sensing request, where the sensing request includes a first condition, and the first condition includes a geographical location requirement for a sensing terminal to participate in sensing, and/or a measurement quantity value requirement corresponding to the geographical location requirement;
a first determining module 132, configured to determine, according to the first condition, whether the apparatus is capable of participating in sensing; and
a sending module 133, configured to: in a case that the apparatus is capable of participating in the sensing, send a sensing response.

In this embodiment of this application, the sensing terminal selection apparatus receives the first condition for selecting the sensing terminal, determines, according to the first condition, whether the condition is fulfilled, and reports to a network side, to resolve a problem that the network side cannot know a terminal suitable for sensing in a sensing area.

In some embodiments, the measurement quantity value requirement includes at least one of the following:
a downlink received signal strength measurement value requirement;
a signal-to-noise ratio requirement;
a downlink reference signal received power measurement value requirement;
a downlink reference signal received quality measurement value requirement;
a downlink reference signal time difference measurement value requirement; and
a downlink angle-of-departure measurement value requirement.

In some embodiments, the measurement quantity value requirement includes a measurement value requirement for a downlink signal of one or more base stations.

In some embodiments, the measurement quantity value requirement includes a measurement value requirement for a signal of one or more beams.

In some embodiments, the sensing request further includes an identifier of a second device for receiving the sensing response and/or a candidate sensing terminal quantity indication. The sending module 133 is configured to send the sensing response to the second device for receiving the sensing response.

In some embodiments, the receiving module 131 is configured to receive the sensing request sent by a base station, where the sensing request is carried in a paging message, a cell system message, or a dedicated RRC message.

In some embodiments, the first determining module 132 is configured to determine, according to a result of currently completed downlink signal measurement, whether the first condition is fulfilled; or measure a downlink signal according to the first condition, and determine, according to a measurement result, whether the first condition is fulfilled.

In some embodiments, the first determining module 132 is configured to: in a case that the first condition is fulfilled, determine that the apparatus is capable of participating in the sensing; or in a case that the first condition is fulfilled, determine, according to a status of the apparatus, whether the apparatus is capable of participating in the sensing.

In some embodiments, the sensing request further includes sensing information, and the sensing information includes at least one of the following: cost information for participating in sensing and estimated sensing duration. The first determining module 132 is configured to determine, according to the sensing information, whether the apparatus is capable of participating in the sensing.

In some embodiments, the sensing response includes at least one of the following:
an identifier of the terminal;
indication information indicating that the terminal is willing to participate in sensing;
a measurement quantity value fulfilling the first condition; and
assistance information for assisting in selecting the sensing terminal.

In some embodiments, the sensing terminal selection apparatus 130 further includes:
a connection module, configured to: in a case that the terminal is in an idle state or inactive state, initiate an RRC connection establishment request or an RRC connection resume request to enter a connection state, where a reason for initiating the RRC connection establishment request or the RRC connection resume request is to respond to the sensing request.

The sensing terminal selection apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a network attached storage (NAS), or the like. This is not specifically limited in this embodiment of this application.

The sensing terminal selection apparatus provided in this embodiment of this application can implement the processes implemented in the method embodiment in FIG. 6, and achieve a same technical effect. To avoid repetition, details are not described herein again.

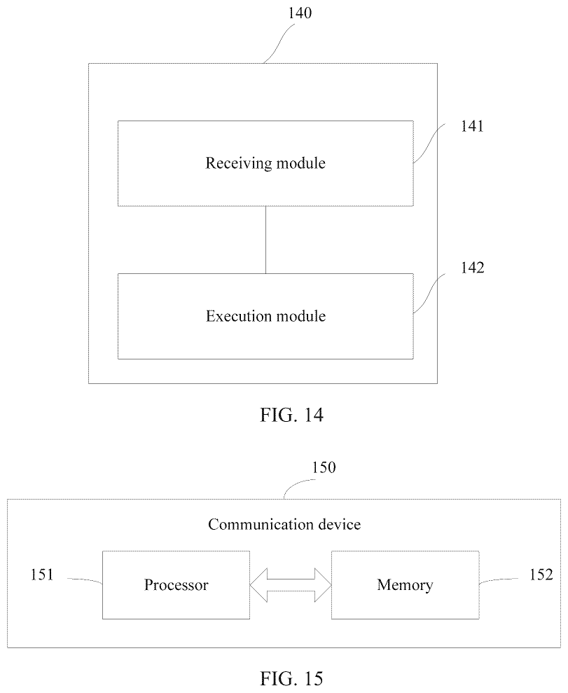

Refer to FIG. 14. An embodiment of this application further provides a sensing terminal selection apparatus 140. The sensing terminal selection apparatus 140 includes:
a receiving module 141, configured to obtain a first condition, where the first condition includes a geographical location requirement for a sensing terminal to participate in sensing, and/or a measurement quantity value requirement corresponding to the geographical location requirement; and
an executing module 142, configured to execute at least one of the following:
determining a candidate sensing terminal list according to the first condition, and sending a sensing response, where the sensing response includes the candidate sensing terminal list; and
broadcasting the first condition.

In this embodiment of this application, the candidate sensing terminal list may be formed by a UE network identifier (such as a RAN-UE-NGAP ID).

In this embodiment of this application, the sensing terminal selection apparatus 140 obtains the first condition, and determines, according to the first condition, the candidate sensing terminal, or broadcasts the first condition, and the terminal determines whether to participate in sensing, to resolve a problem that a network side cannot know a terminal suitable for sensing in a sensing area.

In some embodiments, the measurement quantity value requirement includes at least one of the following:
an uplink received signal strength measurement value requirement and/or a downlink received signal strength measurement value requirement;
a signal-to-noise ratio requirement;
an uplink reference signal received power measurement value requirement and/or a downlink reference signal received power measurement value requirement;
an uplink reference signal received quality measurement value requirement and/or a downlink reference signal received quality measurement value requirement;
a channel impulse response measurement value requirement;
an uplink reference signal time difference measurement value requirement and/or a downlink reference signal time difference measurement value requirement;
a round-trip time measurement value requirement between the base station and a terminal;
an uplink angle-of-arrival measurement value requirement; and
a downlink angle-of-departure measurement value requirement.

In some embodiments, the measurement quantity value requirement includes a measurement value requirement for a downlink signal of one or more base stations, and/or a measurement value requirement on the one or more base stations for an uplink signal of the sensing terminal.

In some embodiments, the measurement quantity value requirement includes a measurement value requirement for a signal of one or more beams.

In some embodiments, the sensing response further includes at least one of the following:
a measurement quantity value fulfilling the first condition; and
assistance information for assisting in selecting the sensing terminal.

The sensing terminal selection apparatus in this embodiment of this application may be an electronic device, for example, an electronic device with an operating system, or may be a component in the electronic device, for example, an integrated circuit or a chip.

The sensing terminal selection apparatus provided in this embodiment of this application can implement the processes implemented in the method embodiment in FIG. 7, and achieve a same technical effect. To avoid repetition, details are not described herein again.

As shown in FIG. 15, an embodiment of this application further provides a communication device 150, including a processor 151 and a memory 152. The memory 152 stores a program or an instruction that is executable on the processor 151. For example, in a case that the communication device 150 is a first device, the program or the instruction is executed by the processor 151 to implement the steps of the embodiment of the sensing terminal selection method performed by the first device, and a same technical effect can be achieved. In a case that the communication device 150 is a terminal, the program or the instruction is executed by the processor 151 to implement the steps of the embodiment of the sensing terminal selection method performed by the terminal side, and a same technical effect can be achieved. In a case that the communication device 150 is a base station, the program or the instruction is executed by the processor 151 to implement the steps of the embodiment of the sensing terminal selection method performed by the base station side, and a same technical effect can be achieved. To avoid repetition, details are not described herein again.

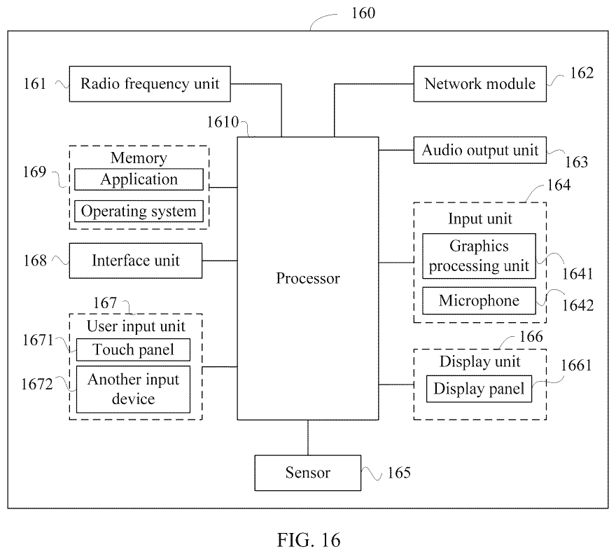

An embodiment of this application further provides a terminal, including a processor and a communication interface. The communication interface is configured to receive a sensing request, where the sensing request includes a first condition, and the first condition includes a geographical location requirement for a sensing terminal to participate in sensing, and/or a measurement quantity value requirement corresponding to the geographical location requirement. The processor is configured to determine, according to the first condition, whether the terminal is capable of participating in sensing. The communication interface is further configured to: in a case that the terminal is capable of participating in the sensing, send a sensing response. The terminal embodiment corresponds to the terminal side method embodiment, each implementation process and implementation of the method embodiment can be applied to the terminal embodiment, and a same technical effect can be achieved. FIG. 16 is a schematic diagram of a hardware structure of a terminal according to an embodiment of this application.

The terminal 160 includes but is not limited to at least a part of components such as a radio frequency unit 161, a network module 162, an audio output unit 163, an input unit 164, a sensor 165, a display unit 166, a user input unit 167, an interface unit 168, a memory 169, and a processor 1610.

A person skilled in the art can understand that the terminal 160 may further include a power supply (such as a battery) that supplies power to each component. The power supply may be logically connected to the processor 1610 by using a power supply management system, to implement functions such as charging and discharging management, and power consumption management by using the power supply management system. The terminal structure shown in FIG. 16 constitutes no limitation on the terminal, and the terminal may include more or fewer components than those shown in the figure, or combine some components, or have different component arrangements. Details are not described herein.

It should be understood that in this embodiment of this application, the input unit 164 may include a Graphics Processing Unit (GPU) 1641 and a microphone 1642. The GPU 1641 processes image data of a static picture or a video obtained by an image capture apparatus (for example, a camera) in a video capture mode or an image capture mode. The display unit 166 may include a display panel 1661, and the display panel 1661 may be configured in a form of a liquid crystal display, an organic light-emitting diode, or the like. The user input unit 167 includes at least one of a touch panel 1671 and another input device 1672. The touch panel 1671 is also referred to as a touchscreen. The touch panel 1671 may include two parts: a touch detection apparatus and a touch controller. The another input device 1672 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 161 may transmit the downlink data to the processor 1610 for processing. In addition, the radio frequency unit 161 may send uplink data to the network side device. Generally, the radio frequency unit 161 includes but is not limited to an antenna, an amplifier, a transceiver, a coupler, a low noise amplifier, a duplexer, and the like.

The memory 169 may be configured to store a software program or an instruction and various data. The memory 169 may mainly include a first storage area for storing a program or an instruction and a second storage area for storing data. The first storage area may store an operating system, and an application or an instruction required by at least one function (for example, a sound playing function or an image playing function). In addition, the memory 169 may be a volatile memory or a non-volatile memory, or the memory 169 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a random access memory (Random Access Memory, RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and Direct Rambus RAM (DRRAM). The memory 169 in this embodiment of this application includes but is not limited to these memories and any memory of another proper type.

The processor 1610 may include one or more processing units. In some embodiments, an application processor and a modem processor are integrated into the processor 1610. The application processor mainly processes an operating system, a user interface, an application, or the like. The modem processor mainly processes a wireless communication signal, for example, a baseband processor. It may be understood that the modem processor may not be integrated into the processor 1610.

The radio frequency unit 161 is configured to receive a sensing request, where the sensing request includes a first condition, and the first condition includes a geographical location requirement for a sensing terminal to participate in sensing, and/or a measurement quantity value requirement corresponding to the geographical location requirement.

The processor 1610 is configured to determine, according to the first condition, whether the apparatus is capable of participating in sensing.

The radio frequency unit 161 is further configured to: in a case that the terminal is capable of participating in the sensing, send a sensing response.

In this embodiment of this application, the terminal receives the first condition for selecting the sensing terminal, determines, according to the first condition, whether the condition is fulfilled, and reports to a network side, to resolve a problem that the network side cannot know a terminal suitable for sensing in a sensing area.

In some embodiments, the measurement quantity value requirement includes at least one of the following:
a downlink received signal strength measurement value requirement;
a signal-to-noise ratio requirement;
a downlink reference signal received power measurement value requirement;
a downlink reference signal received quality measurement value requirement;
a downlink reference signal time difference measurement value requirement; and
a downlink angle-of-departure measurement value requirement.

In some embodiments, the measurement quantity value requirement includes a measurement value requirement for a downlink signal of one or more base stations.

In some embodiments, the measurement quantity value requirement includes a measurement value requirement for a signal of one or more beams.

In some embodiments, the sensing request further includes an identifier of a second device for receiving the sensing response and/or a candidate sensing terminal quantity indication. The radio frequency unit 161 is configured to send the sensing response to the second device for receiving the sensing response.

In some embodiments, the radio frequency unit 161 is configured to receive the sensing request sent by a base station, where the sensing request is carried in a paging message, a cell system message, or a dedicated RRC message.

In some embodiments, the processor 1610 is configured to determine, according to a result of currently completed downlink signal measurement, whether the first condition is fulfilled; or measure a downlink signal according to the first condition, and determine, according to a measurement result, whether the first condition is fulfilled.

In some embodiments, the processor 1610 is configured to: in a case that the first condition is fulfilled, determine that the terminal is capable of participating in the sensing; or in a case that the first condition is fulfilled, determine, according to a status of the apparatus, whether the terminal is capable of participating in the sensing.

In some embodiments, the sensing request further includes sensing information, and the sensing information includes at least one of the following: cost information for participating in sensing and estimated sensing duration. The processor 1610 is configured to determine, according to the sensing information, whether the terminal is capable of participating in the sensing.

In some embodiments, the sensing response includes at least one of the following:
an identifier of the terminal;
indication information indicating that the terminal is willing to participate in sensing;
a measurement quantity value fulfilling the first condition; and
assistance information for assisting in selecting the sensing terminal.

In some embodiments, the processor 1610 is configured to: in a case that the terminal is in an idle state or inactive state, initiate an RRC connection establishment request or an RRC connection resume request to enter a connection state, where a reason for the terminal to initiate the RRC connection establishment request or the RRC connection resume request is to respond to the sensing request.

An embodiment of this application further provides a base station, including a processor and a communication interface. The processor is configured to obtain a first condition, where the first condition includes a geographical location requirement for a sensing terminal to participate in sensing, and/or a measurement quantity value requirement corresponding to the geographical location requirement; and execute at least one of the following:
determining a candidate sensing terminal list according to the first condition, and sending a sensing response, where the sensing response includes the candidate sensing terminal list; and
broadcasting the first condition.

The base station embodiment corresponds to the base station method embodiment, each implementation process and implementation of the method embodiment can be applied to the base station embodiment, and a same technical effect can be achieved.

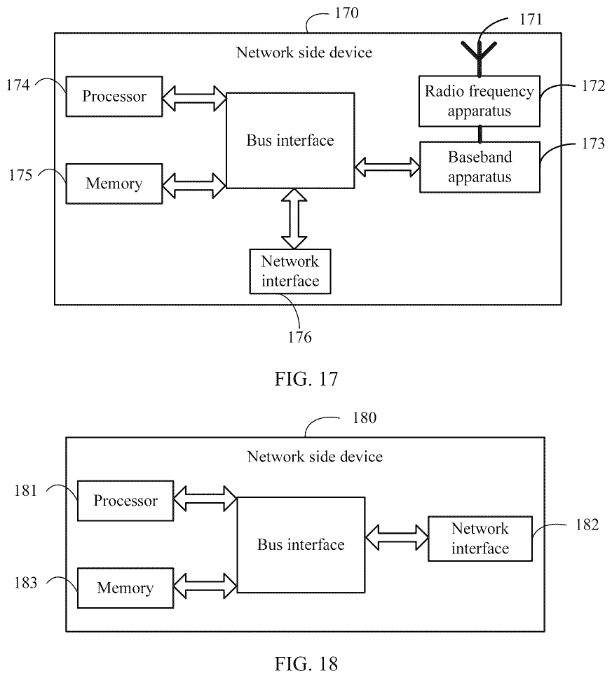

An embodiment of this application further provides a network side device. As shown in FIG. 17, the network side device 170 includes an antenna 171, a radio frequency apparatus 172, a baseband apparatus 173, a processor 174, and a memory 175. The antenna 171 is connected to the radio frequency apparatus 172. In an uplink direction, the radio frequency apparatus 172 receives information through the antenna 171, and sends the received information to the baseband apparatus 173 for processing. In a downlink direction, the baseband apparatus 173 processes information that needs to be sent, and sends processed information to the radio frequency apparatus 172. The radio frequency apparatus 172 processes the received information, and sends processed information through the antenna 171.

In the foregoing embodiment, the method performed by the network side device may be implemented in the baseband apparatus 173. The baseband apparatus 173 includes a baseband processor.

For example, the baseband apparatus 173 may include at least one baseband board. Multiple chips are disposed on the baseband board. As shown in FIG. 17, one chip is, for example, a baseband processor, and is connected to the memory 175 through a bus interface, to invoke a program in the memory 175 to perform the operations of the network device shown in the foregoing method embodiment.

The network side device may further include a network interface 176, and the interface is, for example, a common public radio interface (CPRI).

The network side device 170 in this embodiment of this application further includes an instruction or a program that is stored in the memory 175 and that is executable on the processor 174. The processor 174 invokes the instruction or the program in the memory 175 to execute the method executed by the modules shown in FIG. 14, and a same technical effect is achieved. To avoid repetition, details are not described herein again.

An embodiment of this application further provides a network side device. As shown in FIG. 18, the network side device 180 includes a processor 181, a network interface 182, and a memory 183. The network interface 182 is, for example, a CPRI.

The network side device 180 in this embodiment of this application further includes an instruction or a program that is stored in the memory 183 and that is executable on the processor 181. The processor 181 invokes the instruction or the program in the memory 183 to execute the method executed by the modules shown in FIG. 12, and a same technical effect is achieved. To avoid repetition, details are not described herein again.

An embodiment of this application further provides a readable storage medium. The readable storage medium stores a program or an instruction, and the program or the instruction is executed by a processor to implement the sensing terminal selection method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the sensing terminal selection method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the program/program product is executed by at least one processor to implement the processes of the sensing terminal selection method embodiment, and a same technical effect can be achieved. To avoid repetition, details are not described herein again.

An embodiment of this application further provides a communication system, including a sensing function node and a terminal. The sensing function node may be configured to perform the steps of the sensing terminal selection method performed by the first device, and the terminal may be configured to perform the steps of the sensing terminal selection method performed by the terminal.

An embodiment of this application further provides a communication system, including a sensing function node and a base station. The sensing function node may be configured to perform the steps of the sensing terminal selection method performed by the first device, and the base station may be configured to perform the steps of the sensing terminal selection method performed by the base station.

An embodiment of this application further provides a communication system, including a base station and a terminal. The base station may be configured to perform the steps of the sensing terminal selection method performed by the first device, and the terminal may be configured to perform the steps of the sensing terminal selection method performed by the terminal.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A sensing terminal selection method, comprising:
determining, by a first device, a first condition for selecting a sensing terminal, wherein the first condition comprises a geographical location requirement for the sensing terminal to participate in sensing, or a measurement quantity value requirement corresponding to the geographical location requirement.

2. The sensing terminal selection method according to claim 1, wherein the determining, by a first device, a first condition for selecting a sensing terminal comprises:
determining, by the first device, whether a terminal is required to participate in sensing; and
when the first device determines that the terminal is required to participate in the sensing, determining, by the first device, the first condition for selecting the sensing terminal.

3. The sensing terminal selection method according to claim 1, wherein the measurement quantity value requirement comprises at least one of the following:
an uplink received signal strength measurement value requirement or a downlink received signal strength measurement value requirement;
a signal-to-noise ratio requirement;
an uplink reference signal received power measurement value requirement or a downlink reference signal received power measurement value requirement;
an uplink reference signal received quality measurement value requirement or a downlink reference signal received quality measurement value requirement;
a channel impulse response measurement value requirement;
an uplink reference signal time difference measurement value requirement or a downlink reference signal time difference measurement value requirement;
a round-trip time measurement value requirement between a base station and a terminal;
an uplink angle-of-arrival measurement value requirement;
a downlink angle-of-departure measurement value requirement;
a measurement value requirement on the terminal for a downlink signal of one or more base stations; or
a measurement value requirement on the one or more base stations for an uplink signal of the terminal.

4. The sensing terminal selection method according to claim 1, wherein the geographical location requirement comprises at least one of the following:
a geographical location at which a terminal is required to participate in sensing when a sensing manner is that a base station sends a sensing signal and the terminal receives the sensing signal and performs sensing measurement;
a geographical location at which a terminal is required to participate in sensing when a sensing manner is that the terminal sends a sensing signal and a base station receives the sensing signal and performs sensing measurement;
a geographical location at which a terminal is required to participate in sensing when a sensing manner is that the terminal sends a sensing signal and the terminal receives the sensing signal and performs sensing measurement; or
a geographical location at which a terminal is required to participate in sensing when a sensing manner is that the terminal sends a sensing signal and another terminal receives the sensing signal and performs sensing measurement.

5. The sensing terminal selection method according to claim 1, wherein the first device is a sensing function node, and after the determining, by a first device, a first condition for selecting a sensing terminal, the method further comprises:
sending, by the sensing function node, a second sensing request to a base station, wherein the second sensing request comprises the first condition and an identifier of a second device for receiving a sensing response, and the second sensing request is broadcast by the base station.

6. A sensing terminal selection method, comprising:
receiving, a terminal, a sensing request, wherein the sensing request comprises a first condition, and the first condition comprises a geographical location requirement for a sensing terminal to participate in sensing, or a measurement quantity value requirement corresponding to the geographical location requirement;
determining, by the terminal according to the first condition, whether the terminal is capable of participating in sensing; and
when the terminal is capable of participating in the sensing, sending, by the terminal, a sensing response.

7. The sensing terminal selection method according to claim 6, wherein the measurement quantity value requirement comprises at least one of the following:
a downlink received signal strength measurement value requirement;
a signal-to-noise ratio requirement;
a downlink reference signal received power measurement value requirement;
a downlink reference signal received quality measurement value requirement;
a downlink reference signal time difference measurement value requirement; or
a downlink angle-of-departure measurement value requirement.

8. The sensing terminal selection method according to claim 7, wherein the measurement quantity value requirement comprises:
a measurement value requirement for a downlink signal of one or more base stations; or
a measurement value requirement for a signal of one or more beams.

9. The sensing terminal selection method according to claim 6, wherein the sensing request further comprises an identifier of a second device for receiving the sensing response or a candidate sensing terminal quantity indication; and
the sending, by the terminal, a sensing response comprises: sending, by the terminal, the sensing response to the second device for receiving the sensing response.

10. The sensing terminal selection method according to claim 6, wherein the determining, by the terminal according to the first condition, whether the terminal is capable of participating in sensing comprises:
determining, by the terminal according to a result of currently completed downlink signal measurement, whether the first condition is fulfilled; or
measuring, by the terminal, a downlink signal according to the first condition, and determining, according to a measurement result, whether the first condition is fulfilled.

11. The sensing terminal selection method according to claim 6, wherein the determining, by the terminal according to the first condition, whether the terminal is capable of participating in sensing comprises:
when the first condition is fulfilled, determining, by the terminal, that the terminal is capable of participating in the sensing; or
when the first condition is fulfilled, determining, by the terminal according to a status of the terminal, whether the terminal is capable of participating in the sensing.

12. The method according to claim 11, wherein the sensing request further comprises sensing information, and the sensing information comprises at least one of the following: cost information for participating in sensing or estimated sensing duration; and
the determining, by the terminal according to a status of the terminal, whether the terminal is capable of participating in the sensing comprises: determining, by the terminal according to the sensing information, whether the terminal is capable of participating in the sensing.

13. The method according to claim 6, wherein the sensing response comprises at least one of the following:
an identifier of the terminal;
indication information indicating that the terminal is willing to participate in sensing;
a measurement quantity value fulfilling the first condition; or
assistance information for assisting in selecting the sensing terminal.

14. A sensing terminal selection method, comprising:
obtaining, by a base station, a first condition, wherein the first condition comprises a geographical location requirement for a sensing terminal to participate in sensing, or a measurement quantity value requirement corresponding to the geographical location requirement;
executing, by the base station, at least one of the following:
determining a candidate sensing terminal list according to the first condition, and sending a sensing response, wherein the sensing response comprises the candidate sensing terminal list; or
broadcasting the first condition.

15. The sensing terminal selection method according to claim 14, wherein the measurement quantity value requirement comprises at least one of the following:
an uplink received signal strength measurement value requirement or a downlink received signal strength measurement value requirement;
a signal-to-noise ratio requirement;
an uplink reference signal received power measurement value requirement or a downlink reference signal received power measurement value requirement;
an uplink reference signal received quality measurement value requirement or a downlink reference signal received quality measurement value requirement;
a channel impulse response measurement value requirement;
an uplink reference signal time difference measurement value requirement or a downlink reference signal time difference measurement value requirement;
a round-trip time measurement value requirement between the base station and a terminal;
an uplink angle-of-arrival measurement value requirement; or
a downlink angle-of-departure measurement value requirement.

16. The sensing terminal selection method according to claim 15, wherein the measurement quantity value requirement comprises:
a measurement value requirement for a downlink signal of one or more base stations;
a measurement value requirement on the one or more base stations for an uplink signal of the sensing terminal; or
a measurement value requirement for a signal of one or more beams.

17. The sensing terminal selection method according to claim 14, wherein the sensing response further comprises at least one of the following:
a measurement quantity value fulfilling the first condition; or
assistance information for assisting in selecting the sensing terminal.

18. A communication device, comprising: a memory storing a computer program; and a processor coupled to the memory and configured to execute the computer program to perform the sensing terminal selection method according to claim 1.

19. A communication device, comprising: a memory storing a computer program; and a processor coupled to the memory and configured to execute the computer program to perform the sensing terminal selection method according to claim 6.

20. A communication device, comprising: a memory storing a computer program; and a processor coupled to the memory and configured to execute the computer program to perform the sensing terminal selection method according to claim 14.
